(19) United States
(12) Patent Application Publication
(10) Pub. No.: US 2008/0228582 A1
(43) Pub. Date: Sep. 18, 2008

(54) LOYALTY PROGRAM FOR MERCHANT INVENTORY

(76) Inventors: Edward W. Fordyce, Larkspur, CO (US); Sarah Pankratz Suarez, South San Francisco, CA (US)

Correspondence Address: Quarles & Brady LLP, TWO NORTH CENTRAL AVENUE, One Renaissance Square, PHOENIX, AZ, 85004-2391, US

(21) Appl. No.: 12/048,177

(22) Filed: Mar. 13, 2008

Related U.S. Application Data
(60) Provisional application No. 60/895,111, filed on Mar. 15, 2007.

(51) Int. Cl. G06Q 30/00

(52) U.S. Cl. 705/14

(57) ABSTRACT

Collaborative constituents collaborate to develop offers on selected inventory items of a merchant as part of a loyalty program within a transaction processing system. An inventory management system of the merchant includes an application rendering a hyperlink capable of transmitting a request to collaborate to a web server and to include information on the selected inventory item within the request. Upon establishing a connection with the web server, transmissions addressed to the collaborative constituents are formed and received from the collaborative constituents containing suggested parameters for the loyalty program. At least one remaining parameter for the loyalty program that a set of remaining collaborative constituents have agreed upon is determined. Another transmission addressed to each of the collaborative constituents in the set of remaining collaborative constituents is formed, the another transmission including the remaining parameters for the loyalty program.

### CROSS-REFERENCE TO RELATED APPLICATIONS

This non-provisional application claims priority to, and the benefit of, U.S. Application Ser. No. 60/895,111, filed Mar. 15, 2007, entitled “Point Of Service Discounting,” U.S. application Ser. No. 11/767,202, filed Jun. 22, 2007, entitled “Loyalty Program Service,” U.S. application Ser. No. 11/848,112, filed Aug. 30, 2007, entitled “Loyalty Program Incentive Determination,” and U.S. application Ser. No. 11/848,179, filed Aug. 30, 2007, entitled “Loyalty Program Parameter Collaboration.”

### FIELD

The present invention generally relates to loyalty programs and more particularly, to methods, systems and apparatus for using a graphical user interface to collaborate on parameters of a loyalty program.

### BACKGROUND

Loyalty programs provide consumers with rewards to shop at certain loyalty program participating facilities or to show loyalty to a particular merchant or service provider, such as a financial institution. In addition, to receiving discounts or financial awards, an reward may include redeemable goods or services, or special recognition of some sort, such as an upgrade. Often, financial institutions, such as an issuing bank or acquiring bank, support the loyalty program. Loyalty programs may be associated with various transaction programs such as a credit card program, a charge card program, a debit card program, a prepaid card program, or a gift card program.

A degree of success of a loyalty program is how well it can target consumers that will participate in the program in order to receive the rewards described and provided as part of the loyalty program.

These loyalty programs are typically constructed, marketed, qualified, fulfilled, or refined with limited interaction between the various participants of the programs, which may include merchants, financial institutions such as acquirers and issuers, transaction handlers such as credit card companies, and consumers such as an account holder. For example, a merchant wishing to participate in a co-branded credit card program may be confined to loyalty program parameters set by the issuing bank such as a credit limit, a bonus mile to purchase ratio, or a redemption option, thereby not being able to finely target the merchant's potential consumers. The level of loyalty program parameter confinement is especially prominent among merchants with a smaller portion of the market.

Moreover, loyalty programs may be developed with limited access to detailed transaction data (e.g., information on multiple financial transactions between merchants and consumers). For example, some loyalty program participants, such as issuers, may rely on their own transaction data history to determine the type of reward to provide. However, this data history may be limited in scope depending on the degree of transaction specificity the loyalty program participants collects or is able to maintain. Similarly, merchants wishing to set up a loyalty program may solicit financial institutions for information, gaining limited access to the full scope of the transaction data. Even if the merchant gains access to the transaction data, the transaction data may not be in a form the merchant can effectively utilize.

The lack of uniformity in handing transaction data may hamper accurate communication between participants of the loyalty program. For example, acquirers may identify a single merchant differently; one acquirer may identify a merchant by its name and address while another acquirer may identify the same merchant by its name and franchise store number. Similarly, each participant of the loyalty program may be accustomed to processing transaction data in a particular format that may not be the same as the format of another participant of the loyalty program. For example, an airline company may analyze transaction data in units of “bonus miles per dollar” while an issuer may record dollars spent per month.

Therefore, packaged loyalty program services of a financial institution may not properly meet the needs of merchants that could otherwise benefit from loyalty programs. Often, loyalty program participants lack detailed information about transactions and, thus, fail to create an effective and targeted program that is refined to meet the specific needs of those funding the programs. It would be an advance in the art to provide a platform for collaborating to develop, implement and refine transaction programs in a way that lessens the foregoing drawbacks.

### COPYRIGHT

Contained herein are materials subject to copyright protection. The copyright owner has no objection to the facsimile reproduction of the patent disclosure by any person as it appears in the Patent and Trademark Office patent files or records, but otherwise reserves all rights to the copyright whatsoever.

### SUMMARY

Collaborative constituents within a transaction processing system collaborate on developing, implementing, and refining a loyalty program having an offer on a selected inventory item of the merchant. In one implementation, the collaborative constituents such as a consumer, an issuer, an acquirer, a merchant, or a transaction handler, collaborate on parameters for the offer within the loyalty program. The parameters, for example, may be the duration of the offer within the loyalty program, the value of the offer, or a loyalty program business rule such as an algorithm to determine whether a purchase qualifies for the offer. A graphical user interface may render a menu of a plurality of inventory items of a merchant and a loyalty program collaborative offer icon corresponding to a hyperlink for an address of a host computer. Communication with collaborative constituents can occur upon the selection of the hyperlink and a menu selection of one of the inventory items from the menu. A request may be formed that is addressed for transmission to the host computer, wherein the request can include the selected inventory item and an identifier for the merchant. The collaboration may occur through forming of a proposal addressed at least one collaborative constituent in accordance with a first workflow identifying a predefined order thereof. The proposal may including parameters for a loyalty program including an offer to the consumer to conduct a transaction with the merchant for the selected inventory item, wherein the consumer is to receive a reward upon conducting the transaction and satisfaction of a condition of the reward and the transaction is made payable upon an account that is issued by an issuer to the consumer. A response to the proposal from the addressed at least one collaborative constituent is received. A reply for delivery to the host computer is received including an address of at least one collaborative constituent in accordance with a second workflow identifying a predefined order of delivery thereof. A negotiated set of the parameters is received for the loyalty program to which each remaining of the collaborative constituent has agreed.

In another implementation, a user interface is used to select an inventory item of the merchant for an offer that is proposed as part of the loyalty program being collaborate among the collaborative constituents. The user interface may include means for inputting data, a menu including a plurality of selectable inventory items of the merchant; an inventory selection region for receiving a selection from the means for inputting data of one of the inventory item from the menu, and a loyalty program collaborative offer icon. The means for inputting data is operable with the loyalty program collaborative offer icon to activate a function of an application executing on a client that addresses a request to a web service to initiate a loyalty program collaboration on a loyalty program having an offer on the selected inventory item from the menu. Moreover, the request includes: the selected inventory item from the menu; and an identifier for the merchant, wherein the menu, the inventory selection region, and the loyalty program collaborative offer icon are rendered to a display of the client by the executing application.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a block level diagram illustrating an exemplary system for collaborating to develop, implement, and refine a loyalty program via a platform configured to be accessible to various collaborative constituents;

FIG. 2 is a schematic illustrating an exemplary network in which a merchant is communicatively connected to the system illustrated in FIG. 1;

FIG. 3 illustrates a flow chart of an exemplary method for collaborating to develop, implement, and refine a loyalty program having at least one parameter;

FIG. 4 is a schematic of an exemplary transaction lifecycle the phases of which can be facilitated within the system illustrated in FIG. 1;

FIG. 5 is a schematic illustrating an exemplary platform included in the system illustrated in FIG. 1 and components of a loyalty program;

FIG. 6 illustrates an exemplary Graphical User Interface rendering a loyalty program collaborative offer icon referencing the platform in FIG. 1;

FIG. 7 illustrates an exemplary offer management screen through which offers for consumers can be designed and implemented;

FIG. 8 illustrates a data input screen in which an offer can be created;

FIG. 9 is a continued explanation of the input screen seen in FIG. 8;

FIG. 10 illustrates a screen depicting a “Campaign” screen;

FIG. 11 illustrates a screen depicting a list of approved offers;

FIG. 12 illustrates a screen depicting aspects of approved offers;

FIG. 13 illustrates a screen shot for approved campaigns as indicated at reference numeral 1302; and

FIG. 14 is a block level diagram illustrating an exemplary transaction processing system that can include the system illustrated in FIG. 1.

### DETAILED DESCRIPTION

Implementations enable collaborative constituents to collaborate to construct, implement, refine, or a combination thereof, a loyalty program. For example, entities within a transaction processing system (e.g., payment processing system) may become collaborative constituents collaborating during various phases of the loyalty program. The transaction processing system may include: a transaction handler (e.g., a credit card company), an issuer, an acquirer, a consumer, and a merchant. For example, the merchant can use a computer, such as a personal computer or a Point of Service (POS) device having an application that addresses, to a platform within a network, a request to form parameters for an offer on a selected inventory item of the merchant. The offer may be targeted to a set of eligible consumers having an account within the transaction processing system. The offer can be marketed to the set of eligible consumers. Each of the consumers within the set of eligible consumers may accept the offer and engage in a transaction with the merchant in accordance with the parameters of the offer within the loyalty program. The offer can then be honored, such as by applying a discount at the time of purchase or by facilitating a credit to the account within the transaction processing system.

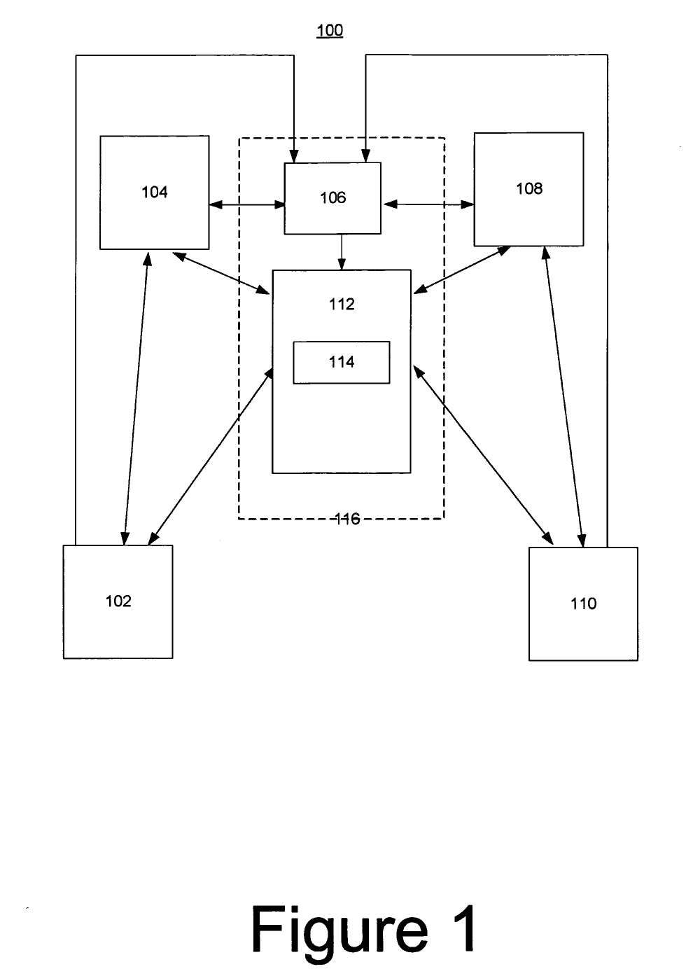

Referring to FIG. 1, an exemplary system or environment is illustrated for collaborative constituents to collaborate on developing, implementing, and refining a loyalty program 114 via a platform 112.

The collaborative constituent may include a consumer 102 such as the consumer in the transaction processing system, an issuer 104 such as the issuer, a transaction handler 106 such as the transaction handler, an acquirer 108 such as the acquirer, or a merchant 110 such as the merchant. The merchant 110 may be a person or entity that sells a inventory item such as a good, a service, or a combination thereof. Examples of the merchant 110 include: a manufacturer, a distributor, a retailer, a load agent, a service provider, or a healthcare provider. In a business-to-business setting, the consumer 102 may be a second of the merchant 110 making a purchase from a first of the merchant 110. Third-party processors may perform many operational support tasks on behalf of the collaborative constituent. The third-party processors may be creative agencies, loyalty program marketing agencies or consultants, business intelligence companies or consultants, letter shops, Email and Short Message Service (SMS) or Text message delivery agencies, and registered card loyalty program companies.

The platform 112 can be a forum accessible via a network, the Internet, an extranet, a wireless network, a wire line network, a local area network, a wide area network, a messaging system, a correspondence system, or a telephone system that is a market place for collaborative constituents to interact to construct, implement, and refine the loyalty program 114. The platform 112 may be a part of the transaction handler 106 as denoted by broken lines 116 in FIG. 1.

The collaborative constituents can access the platform 112, via the Internet for example, to negotiate parameters of the loyalty program 114. Collaborative constituents may form transmissions addressed to other collaborative constituents proposing parameters for the loyalty program 114, receiving a response to the proposal, and replying to the response.

A parameter may include, for example, the duration of a promotion (e.g., offer) within the loyalty program 114, the good or service promoted, the value of the promotion, or a loyalty program business rule such as an algorithm to determine whether a purchase qualifies for the promotion. To illustrate, the merchant 110 may propose a loyalty program business rule as a parameter having a form of: “if variable one occurs then provide reward.” Standard promotions that the merchant 110 may propose include: discounts (e.g., “if you use a Nordstrom® credit card you can receive ten (10%) percent off a purchase of socks”), rewards, coupons, and spent-and-get promotions. A coupon promotion may be structured such that if the consumer 102 uses an account associated with the transaction processing system to make a purchase at the merchant 110 store that exceeds $100 U.S. in value, then ten (10) percent will be taken off the purchase value at the POS device of the merchant 110. Similarly, the promotion may be a spend-and-get promotion such as if the consumer 102 conducts four purchases made with the account associated with the transaction processing system at a store of the merchant 110, a fifth purchase by the consumer 102 at the store will result in $10.00 U.S. being credited to the account. Other rewards that can be included in the loyalty program business rule include: an upgrade in a value of a inventory item being purchased, a discount on a price of the inventory item being purchased, a rebate, a statement credit for an account within the transaction processing system and associated to the consumer 102, or a combination of the foregoing.

The collaborative constituents may repeat the process of proposal, response, and reply to refine or alter the remaining set of parameters of the loyalty program 114 based in part on the transaction data for a plurality of purchases, analysis on the transaction data for a plurality of purchases, or combinations thereof, for example. Once a negotiated set of parameters for the loyalty program 114 is agreed upon, a negotiated agreement to the parameters of the loyalty program 114 is formed. The negotiated set of parameters for the loyalty program 114 are those parameters that remain after the negotiation is completed among the collaborative constituents, such that the collaborative constituents left in the negotiation process all agree to the remaining parameters. Thereafter, the collaborative constituents can implement and refine or alter the remaining parameters of the loyalty program 114, such as by changing a value of an reward associated with the loyalty program.

A participant of the loyalty program 114 can be, but need not be one of the collaborative constituent. For example, the franchisor, McDonald's Corporation, may be one of the collaborative constituents having a McDonald's® loyalty program accessible through the platform 112 and a McDonald's® loyalty program participant; however, a single McDonald's® store located in Los Angeles, Calif. may not be one of the collaborative constituents but be one of the McDonald's® loyalty program participant wherein purchases made at the single McDonald's® restaurant would qualify for the McDonald's® loyalty program.

The platform 112 can be scaled to meet the needs of any number of the collaborative constituents. For example, the platform 112 may be configured to accommodate a small or a large number of collaborative constituents, globally, in multiple languages.

The platform 112 can be scaled to meet the needs of the participants of the loyalty program 114. For example, the number of participants of the loyalty program 114 for each entity may vary, such as having several franchisees as the participants of the loyalty program 114 for a single franchisor. Similarly, the platform 112 may be configured to allow different numbers of entities to participate in the loyalty program 114. For example, the merchant 110 can be one of the merchants 110 that may interact with a single financial institution to create and maintain the loyalty program 114. Conversely, a large number of the merchants 110 can create the loyalty program 114 through interaction with a large number of the financial institutions. For example, all of the merchants 110 selling clothing in the southwest can interact with several banks, such as Wells Fargo and Bank of America, to create and maintain the loyalty program 114.

Moreover, the platform 112 may be configured to accommodate modularity in the loyalty program 114. The modularity in the loyalty program 114 includes the loyalty program 114 that has the characteristic of being versatile, allowing for a combination of diverse parameters. The loyalty program 114 may be created in an a la carte fashion having parameters that mimic those in a pre-existing loyalty program and other parameters that may be unique or did not exist before. For example, the loyalty program 114 may have parameters that include a point to cash back ratio mimicking a pre-existing loyalty program.

The collaborative constituents may set up a profile associated with the platform 112. The profile may include information about the collaborative constituent. For example, the consumer 102 may set up a profile including information such as a name of the consumer 102, an address of the consumer 102, an account number of the consumer 102 for an account within the transaction processing system, inputted data of the consumer 102 such as preference for particular promotion or preference for a channel for receiving promotions, a promotion category within which the consumer 102 would like to receive promotions, or shopping habits of the consumer 102, for example. The issuer 104 may set up a profile including information about the issuer 104 such as an issuer identifier (e.g., a global unique identifier (GUID) that distinguishes the issuer 104 within the transaction processing system); an address of the issuer 104; loyalty program business rules typically proposed by the issuer 104 for a plurality of the loyalty programs 114; fulfillment options of the loyalty program 114 (e.g., credit to statement or cash back); parameters of the loyalty program 114 that the issuer 104 typically proposes, such as branding requirements and other business rules; and information on third parties that act as proxies to the issuer 104. The acquirer 108 may set up a profile including information about the acquirer 108 such as an acquirer identifier (e.g., a GUID that distinguishes the acquirer 108 within the transaction processing system), an address of the acquirer 108, a settlement request, and identification for the merchants 110 that are associated with the acquirer 108, or an accumulated daily sale report of the merchant 110. The transaction handler 106 may set up a profile including information about the transaction handler 106 such as transaction message field formatting requirements, authorization standards for a transaction amount, credit card spending limits for a credit card type, or a demographic analysis.

Similarly, the merchant 110 may set up a profile including information about the merchant 110 such as a merchant identifier (e.g., a GUID for the merchant 110 that distinguishes the merchant 110 within the transaction processing system), a merchant code that may be globally nonunique, franchise codes, or a loyalty program business rules that the merchant 110 typically utilizes, for example. The GUID for the merchant 110 may take the form of a random code; an indicator of a franchiser for one or more of the merchants 110; an indicator of a franchisee store number for the merchant 110; an indicator of a corporate entity associated with the merchant 110; an indicator of a merchant category into which the merchant 110 is classified; an Internet Protocol address of a computer of the merchant 110, a password, a Merchant Category Code, or a combination thereof. The GUID for the merchant 110 may contain information that can categorize the merchant 110 into a merchant category, such as a retail store, having a corresponding merchant code such as “RSTR598183” the first four letters indicating that the merchant is categorized as a Retail SToRe=RSTR. The GUID for the merchant 110 can distinguish the merchant 110 from other merchants within the transaction processing system. For example, an acquirer X may identify a Neiman Marcus® store number 99 by “9999” while another acquirer Y may identify a Safeway® located at 99th Avenue with “9999.” Because “9999” is not unique within the transaction processing system, a purchase at Safeway can not be distinguished from a purchase at Neiman Marcus. On the other hand, if each of the merchants 110 have a unique number within the transaction processing system, purchases at each of a store of the merchants 110 can be distinguished from one another.

Consequently, the platform 112 may facilitate the creation and implementation of a loyalty program 114. For example, the merchant 110 may be an office equipment store. The merchant 110 may have overstocked paper within the month of March; consequently, the office equipment store may wish to provide a promotion to consumers 102 living within five miles from the store of the merchant 110. The office equipment store may use the POS device of the office equipment store to link to the platform 112 in order to collaborate on constructing an offer for a free pack of paper with the purchase of a printer toner.

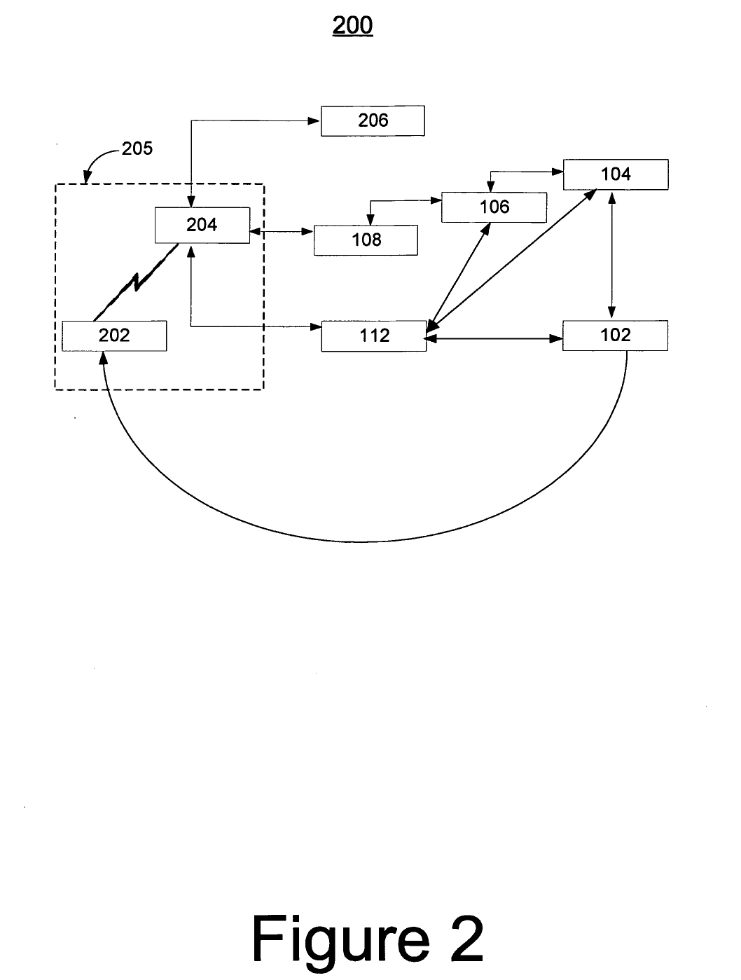

Referring to FIG. 2, an exemplary system illustrates a merchant 110 using the platform 112 to construct, implement, and refine the loyalty program 114. The platform 112 may be accessible to the merchant 110 through the use of a device 205 having a hardware component 202, such as a Computer Processing Unit (CPU), and a software component 204, such as code, microcode, applets, or modules that assist the merchant 110 in conducting its business. The device 205, such as the POS device or a computer of the merchant 110, may access the platform 112 through a network connection. The network may be the Internet, an extranet, a wireless network, a satellite system, a wire line network, a local area network, a wide area network, a messaging system, a correspondence system, or a telephone system.

The device 205 may be multifunctional, such as having the ability to manage inventory, communicate with the platform 112, and conduct transactions. For example, the merchant 110 may use the POS device to manage the inventory of the merchant 110 such as accessing a database containing the Stock Keeping Unit (SKU) for all inventory items within the inventory that are located at the store of the merchant 110 at a point in time. Alternatively or in combination, the merchant 110 may use the device 205 to keep track of the inventory that the merchant 110 intends to purchase from an entity 206, such as a manufacturer or another merchant 110. The device 205 may be in communication with the entity 206 to send out purchase order or to receive shipment information from the manufacturer.

The merchant 110 may use the device 205, to form a request addressed to other collaborative constituents via the platform 112 to set up at least one parameter for the offer within the loyalty program 114 that the merchant 110 wishes to market to the consumers 102.

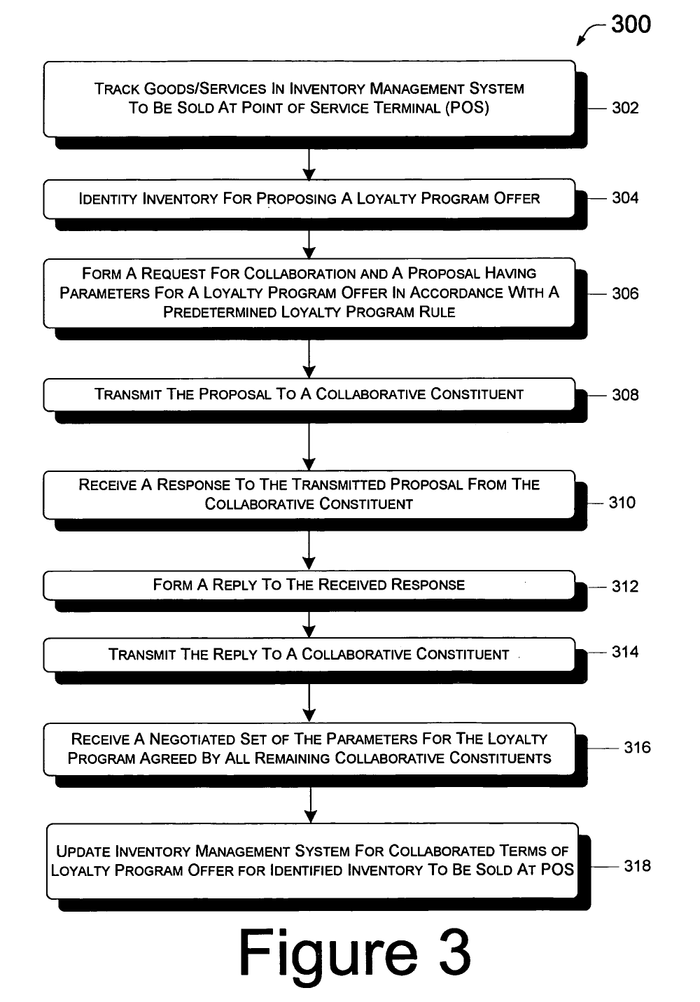

Referring to FIG. 3, an implementation of a method 300 for the collaborate constituent, such the merchant 110, to collaborate to develop and/or refine the loyalty program 114 begins at step 302. At step 302, the merchant 110 tracks the flow of goods or services within the inventory of the merchant 110. The inventory item may be a good or service that the merchant 110 has sold (e.g., a transaction with the consumer 102 such as a lease, a license, or a transfer or ownership) to the consumer 102, a good or services that the merchant 110 has available for sale, or a good or services that the merchant 110 can make available for sale in the future. The inventory may be tracked or managed in an Inventory Management System (“IMS”). The IMS may include a computer software program capable of accessing a database containing data about the inventory of the merchant 110. The IMS may have a graphical user interface (“GUI”) enabling the merchant 110 to enter, delete, and analyze the data about the inventory. The computer software program within the IMS may provide the capability of associating a description with the inventory item, such as a category for the inventory item. The merchant 110 can determine the quantity of the inventory item and the flow of the inventory item into and out of the inventory of the merchant 110 by interacting with the IMS. For example, the merchant 110 may determine that the merchant 110 has had ten widgets in stock at a store of a franchisee for the past three months. An Enterprise Resource Planning (ERP) system may be associated or be part of the IMS. The ERP may be a system that integrates accounts receivable or accounts payable of an organization data into a single unified system within an organization, such as by storing the accounts payables of the organization into a single database.

At step 304, one of the inventory items is identified by the merchant 110 for an offer to be made to the consumer 102 as part of the loyalty program 114. The identified inventory item may become a parameter within the proposal that the merchant 110, as a collaborative constituent, can collaborate on via the platform 112.

The identification of the inventory item for the offer can be manual, automatic, or a combination thereof. For example, the merchant 110 may manually determine that the merchant 110 has overstocked wrenches in the home improvement department of one of the stores of the merchant 110. Consequently, the merchant 110 may identify the wrenches as the inventory item for which the merchant 110 can construct the offer. Alternatively, or in combination, the merchant 110 may use the IMS to automatically identify the inventory item for the offer. The merchant 110 may enter rules into the computer software program included in the IMS such that the executed software is configured to identify the inventory item automatically. An example of one of the rules entered into the computer software may include: “if an inventory item has been in stock but not sold within a predetermined time period the inventory item is identified for one of the offers.” The computer software program included in the IMS be further configured to suggest, via the GUI, the inventory item to the merchant 110 as being a candidate for the offer or may automatically create the offer that is suitable based on the rules entered into the computer software. In another example, the merchant 110 may enter one of the rules into the computer software as “high demand items should be suggested as the inventory item for spend-and-get promotions.” The merchant 110 may have also indicated that a particular one of the inventory items, such as an iPod®, is in high demand. The computer software program within the IMS may automatically generate an offer such as “be the tenth purchaser of an iPod® and receive a free iPod® case.”

At step 306, a request and a proposal having parameters for the offer on the inventory item of the merchant 110 is formed. The request can be initiated by the merchant 110 selecting a loyalty program collaborative offer icon rendered on a GUI of the IMS and corresponding to a hyperlink for an address associated with the platform 112, such as a Uniform Resource Locator. The request can include the selected inventory item and an identifier for the merchant 110, for example. When selected, the hyperlink may activate a function of an application executing on a client within the IMS that addresses a request to a web service to initiate a loyalty program collaboration on the loyalty program 114 having the offer on the selected inventory item. Consequently, the request may include the selected inventory item, the merchant identifier (e.g., such as the GUID of the merchant 110), or other parameters of the offer within the loyalty program 114.

The proposal may include the parameters for the offer on the selected inventory item. One of the parameters may be the indicia on the selected inventory item. Other parameters may the type of offer or the duration of the offer, for example. The offer may be for a consumer to conduct the transaction with the merchant 110 for the selected inventory item, wherein the transaction is made payable upon the account that is issued by the issuer to the consumer.

The proposal may also include the type of the consumer 102 to whom the merchant 110 wishes to target the offer. For example, the merchant 110 may want to target the consumer 102 based on geographical location or a transaction history of the consumer 102. The proposal of the merchant 110 may indicate that the promotion should be targeted to the consumers 102 living within ten miles from the location of one of a franchisee store of the merchant 110. Alternatively, or in combination, the proposal of the merchant 110 may indicate that the promotion should be targeted to the consumers 102 that have purchased a particular good or service in the past—such as the consumers 102 that have purchased baseball cards at competitor stores within the past two months. For example, the merchant 110 may wish to target consumers 102 that have purchased Digital Video Discs “DVDs” in the past, the transaction handler 106 may mine a database containing a plurality of transaction histories of the consumers 102, looking for trends of purchases dealing with DVDs. Moreover, once a set of eligible consumers is identified, the transaction handler 106 may query the merchant 110 to refine the set of eligible consumers.

The proposal may be formed in accordance with a predetermined loyalty program rule. The predetermined loyalty program rule may include rules on the procedure to form and transmitting the proposal and/or rules on the content of the proposal for the loyalty program 114. The predetermined loyalty program rule for the procedure of forming and transmitting the proposal may include: the format of the proposal such as text based message formatting, the prerequisites for submitting a proposal such as identifying the entity making the proposal, or contractual obligations for transmitting a proposal such as an agreement to negotiate in good faith. The predetermined loyalty program rule for the content of the proposal may include rules delineating the types of parameters that can be proposed. For example, the predetermined business rule may require that the loyalty program 114 involve the use of the transaction processing system. To illustrate, the predetermined loyalty program rule may require that the proposal for the loyalty program 114 must reward the use of a particular brand of credit card. Similarly, the predetermined loyalty program rule may require that the transaction messages associated with a transaction be in a particular format, such as magnetic strip format having fields that can be populated. For example, the predetermined loyalty program rule may include a rule for populating the transaction message with an identifier for the merchant 110 such as the GUID for the merchant 110, information on the transaction (e.g., a date or a time of the transaction, a transaction amount, or location), information on the reward (e.g., a value for the reward or an identifier for the reward), or an identifier for a inventory item purchased during the transaction.

At step 308, the proposal is transmitted to a collaborative constituent. A transmission may include the addressed to at least one other collaborative constituent. For example, the proposal can be addressed to the collaborative constituent via an email address. Alternatively, the address can be to a category of collaborative constituents such as “all issuers within the transaction processing system.” A third-party may transmit the proposal to the destined collaborative constituent. The third-party may then transmit the proposal to the collaborative constituent in accordance with a workflow identifying the order of deliver of the proposal addressed to the collaborative constituent(s). The workflow may identify a sequence of collaborative constituents that should receive the proposal such as in a series or parallel sequence. To illustrate, the merchant 110 may form a proposal for a spend-and-get loyalty program (e.g., buy two pairs of shoes get the third pair of shoes free). The merchant 110 may address the proposal to two collaborative constituent that are each issuers 104: Wells Fargo and Bank of America, via the transaction handler 106. The transaction handler 106 may receive the proposal and send the proposal to both Wells Fargo and Bank of America at the same time. The transaction handler 106 may analyze the proposal to make sure it comports with the predetermined loyalty program rule prior to transmitting the proposal to either Wells Fargo or Bank of America.

At step 310, a response from the collaborative constituent to the transmitted proposal is received. The response may be transmitted to the entity that formed the proposal or to another collaborative constituent via a workflow identifying a predefined order of delivery thereof. In the example above, Wells Fargo may wish to respond favorably to a spend-and-get proposal of the merchant 110. Consequently, Wells Fargo may respond by indicating that it will help create and implement the spend-and-get loyalty program for the consumers 102 that are each account holders with Wells Fargo. Wells Fargo may also present a counter proposal in its reply stating that if the spend-and-get loyalty program availability to the consumers 102 is limited to the months of March through May, Wells Fargo can credit the value of the third pair of shoes on the statement of the consumer 102 that is an account holder with Wells Fargo such that the consumer 102 can charge the purchase of the third pair of shoes at the store of the merchant 110 but Wells Fargo will apply a credit for the value of the third pair of shoes to a Wells Fargo® account of the consumer 102. Consequently, the response can be used to further negotiate the parameters of the loyalty program 114 being proposed, for example, by containing a favor or disfavor of the at least one parameter for the loyalty program 114.

The response may contain further detail on how the loyalty program 114 can be implemented. For example, the issuer 104 may respond to the proposal of the merchant 110 for the loyalty program 114 by indicating how the issuer 104 may market the loyalty program 114 to the account holders of the issuer 104, such as: identifying the consumer 102; creating a marketing collateral for the loyalty program 114; delivering the marketing message to at least one of the consumers 102; registering a potential consumer for the loyalty program 114; or a combination of the foregoing.

At step 312, a reply to the response can be formed. The reply may also be in accordance with the predetermined loyalty program rule for the loyalty program 114. For example, the reply may state that the merchant 110 expresses favor to Wells Fargo's response to the spend-and-get loyalty program proposal further indicating that transaction messages from the merchant 110 for each purchase of the consumer 102 will include a code for the spend-and-get loyalty program so that Wells Fargo can distinguish the consumer 102 that has made a purchase toward the spend-and-get loyalty program at the store of the merchant 110. For example, the merchant 110 may populate a field within the transaction message with “SPGT” to distinguish transactions eligible for the spend-and-get loyalty program of the merchant 110. Alternatively, or in combination, the issuer may populate a field within the transaction message with free form text such as “authorized a third purchase for this customer toward Fry's® spend-and-get loyalty program.”

At step 314, the reply is transmitted to at least one collaborative constituent. The reply may be transmitted to any collaborative constituent such as the collaborative constituent that sent the response. For example, the merchant 110 may transmit the reply of favor to Wells Fargo's response by sending the reply in a Short Message Service (SMS) to the transaction handler 106 that forwards the SMS to Wells Fargo. Alternatively, or in combination, the merchant 110 may address the reply to Bank of America inquiring if Bank of America is willing to make a better deal than that sent by Wells Fargo. Bank of America may transmit a Bank of America response including a set of parameters that the merchant 110 may find more favorable.

The workflow for the order of delivery of the proposal, response, or reply may be serial (e.g., sequential such that each addressed collaborative constituent receives the transmission consecutively), parallel (e.g., such that each addressed collaborative constituent receives the transmission concurrently) or a combination thereof. Moreover, the workflow for the proposal, response, or reply may be the same as each other or different from each other. The collaborative constituent can optionally specify the workflow for the order of delivery of each of the proposal, response, or reply.

The steps of 302 through 314 may be repeated until an agreement is reached. For examples, proposals, responses, and replies may contain offers, counteroffers, and acceptances from the collaborative constituents developing the parameters for the loyalty program 114. The repetition of the steps 302 through 316 may take several iterations and collaborative constituents may participate or stop participating at any step of 302 through 316.

The business case for parameters can be made during the negotiation process (e.g., steps 302 through 316). The collaborative constituents may evaluate the business case for the parameter of the offer within the loyalty program 114 and argue its effectiveness to the other collaborative constituents involved in the negation. For example, the business case may entail: determining a cost and a benefit for the parameter; determining a cost and a benefit for not having the parameter; determining a business need that the parameter may address; performing a gap analysis; determining a reason for the parameter; or determining a reasons for one of favoring and disfavoring the parameter.

Analytical tools can assist in evaluating the business case for the parameters of the offer. For example, an input to an algorithm may include one of the parameter for the offer and data on one or more purchases from one or more of the merchants 110 by one or more of the consumers 102. An output of the algorithm may include a quantitative trend within the purchases as a function of the parameter for the loyalty program 114. Any conventional or predetermined algorithm for data analysis may be used for the trend analysis. The analytical tools can include: a data mining tool; a reporting tool; a metrics tool; a demographics tool; an analytic tool; a targeting tool; a statistic tool; a segmentation analysis tool; a tool for determining at least a cost and a benefit for the parameter; a tool for determining at least a cost and a benefit for not having the parameter; a tool for determining the business need that the parameter will address; a tool for gap analysis; a tool for determining a reason for the parameter; a tool for determining the reasons for at least one of favoring and disfavoring the parameter; or a combination of the foregoing.

To illustrate, the consumer 102 who has purchased lawn care items in April for the last four years might be identified as being highly likely to purchase lawn care items this April. In another example, general trends of the consumer 102 may be analyzed to determine highly correlative events, such as “consumers who purchased a pair of shoes also buy a pair of socks within 90 days from the date of purchase of the pair of shoes.” In another example, the consumer 102 purchase behavior trends may be analyzed to reveal the consumers 102 that spend significantly larger amounts in restaurants than average restaurant patrons.

At step 316, a negotiated set of parameters to which all remaining collaborative constituents have communicated favor to the negotiated set of parameters is received, the negotiated set of parameters being the remaining parameters for the loyalty program 114. The negotiated set of parameters can be the minimum parameters that the collaborative constituents need to agree on in order to implement the loyalty program 114. The negotiated set of parameters need not have all of the details to implement the loyalty program 114. For example, the address for the location for all the merchants 110 that will participate in the loyalty program 114 need not be agreed upon among the collaborative constituents. The negotiated set of the parameters for the loyalty program 114 may be received from at least one implementer of the loyalty program 114. Moreover, the remaining collaborative constituents need not communicate favor to each and every parameter in the negotiated set of parameters; rather, the remaining collaborative constituents can communicate favor to the negotiated set of the parameters.

The communicated favor for the negotiated set of parameters forms a negotiated agreement to the negotiated set of parameters that can be communicated to each of the collaborative constituents that remained in the collaboration and agreed to the negotiated set of the parameters. The remaining collaborative constitutes can be those that have not expressed a desire to exit the negotiation process or those that have not contributed to the negotiation process for a period of time (e.g., days or months), such that their lack contribution indicates a desire to exit the negotiation process. For example, the transaction handler 106 may transmit the negotiated set of the parameters for the loyalty program 114 to the remaining set of the collaborative constituents. The transaction handler 106 may determine which of the remaining parameters for the loyalty program 114 the remaining set of collaborative constituents have agreed upon as being the negotiated set of the parameters for the loyalty program 114. The transaction handler 106 may address a second transmission to each of the collaborative constituents among the remaining set of the collaborative constituents including the negotiated set of the parameters for the loyalty program.

At step 316, the IMS is updated for the negotiated set of the parameters of the loyalty program 114. For example, the negotiated set of the parameters of the offer for the inventory item to be sold at the POS device may become an input to the computer program within the IMS. The merchant 110 can then prepare for the implementation of the loyalty program 114 such as by making sure the inventory item offered in the loyalty program 114 is available for purchase for the duration of the offer.

Moreover, the computer program within the IMS may track the success or failure of the offer such as by comparing receipts of sales of the inventory item throughout the duration of the offer with a sales projection for the inventory item generated either through the use of the platform 112 or by the computer program within the IMS or a combination thereof.

To illustrate, the merchant 110 that operates a coffee shop may wish to create and implement a coffee shop loyalty program for its patrons. The merchant 110 may use a cellular telephone with an Internet connection. The merchant 110 may execute the computer program included in the IMS rendering a graphical user interface having a hyperlink to the platform 112. Upon review of the inventory of the coffee shop operator via the graphical user interface, the coffee shop operator may note that he has an overstock of coffee beans and decide to create a spend-and-get offer on coffee. The coffee shop operator may select the hyperlink to the platform 112, and form a transmission addressed to the transaction handler 106 for a spend-and-get offer including the selected inventory item “coffee” and the GUID for the merchant 110. A the proposal may be transmitted indicating that a coffee shop loyalty program should have a spend-and-get offer wherein patrons can purchase ten cups of coffee and receive the eleventh one free. The coffee shop operator may transmit the proposal to the issuer 104, a Wells Fargo® bank, via the platform 112.

The Wells Fargo® bank can transmit a response indicating favor to the coffee offer proposal further indicating that the coffee shop loyalty program should be marketed to patrons living within ten minutes from the coffee shop. The coffee shop operator may agree, submitting a reply to the response expressing favor to the 10-minute limitation not having discussed if the ten minutes is calculated based on using surface streets or the subway. The transaction handler 106 may determine that the coffee shop operator and Wells Fargo® bank have agree that the spend-and-get promotion and the 10-minute limitation are the parameters for the coffee shop loyalty program thereby forming the negotiated agreement for the coffee shop loyalty program even without knowing if the 10-minute limitation is calculated based on using surface streets or the subway. The transaction handler 106 may determine that both the coffee shop operator and Wells Fargo® bank have agree to the remaining parameters for the coffee shop loyalty program by polling the number of favor positions received from each of the coffee shop operator and Wells Fargo® bank for each of the remaining parameters for the coffee shop loyalty program.

Moreover, parameters that do not comply with a predetermined loyalty program rule may be filtered out and not included in the remaining parameter for the coffee shop loyalty program. For example, the coffee shop operator may have proposed a parameter for the coffee shop loyalty program stating that cash purchases count toward the coffee shop loyalty program; however, one of the predetermined loyalty program rules may indicate that only credit purchases may apply toward the loyalty programs 114 developed through the use of the platform 112.

The negotiated agreement for the coffee shop loyalty program, including the negotiated set of parameters, can be communicated back to both the coffee shop operator and the Wells Fargo® bank in a transmission using the workflow or another workflow identifying another predefined order of delivery. The negotiated agreement is communicated to each of remaining set of the collaborative constituents, which may include one of the loyalty program implementers. The coffee shop operator may then update the IMS to reflect the terms and conditions of the spend-and-get offer.

Thereafter, the coffee shop operator may wish to refined or altered the loyalty program 114. The alteration may include renegotiating one of the parameters within the negotiated set of parameters or negotiating a new parameter. The refinement may occur before or after the loyalty program 114 has been implemented as long as the remaining collaborative constituents agree that the negotiated set of parameters can be further negotiated. For example, one of the collaborative constituents within the remaining set of the collaborative constituents may address a transmission to the transaction handler 106 requesting to alter the at least one of the remaining parameter for the loyalty program 114. The request may include an affirmative representation that each of the collaborative constituents in the remaining set of the collaborative constituents have each agreed to the request to alter. Alternatively, or in combination, the transaction handler 106, for example, can determine that each of the collaborative constituents in the remaining set of the collaborative constituents have each agreed to the request to alter, such as by taking a pole through electronic communication with each of the collaborative constituents among the remaining set of the collaborative constituents.

The steps to alter the remaining parameters for the loyalty program may include similar steps as the negotiation process (e.g., steps 302 through 314): a refinement proposal in accordance with the predetermined loyalty program rule can be formed and transmitted to an addressed collaborative constituent; a refinement response from the addressed collaborative constituent can be received, wherein the response is to the transmitted refinement proposal; a refinement reply to the received refinement response in accordance with the predetermined loyalty program rules may be formed and transmitted; a second negotiated set of parameters to which all remaining collaborative constituents have communicated favor to the second negotiated set of parameters can be received, the second negotiated set of parameters being the parameters for the loyalty program 114 that has been refined; and a second negotiated agreement to the second negotiated set can be communicated to each of the of collaborative constituents among a second remaining set of the collaborative constituents.

For example, the coffee shop operator may use the analytical tools available at the platform 112 to evaluate the performance of the spend-and-get of the coffee shop operator after it has been implemented for six months. The analytical tool may isolate all purchases of coffee at the store of the merchant 110 for the past six months across all of the consumers 102 that made a purchase at the store of the merchant 110. The coffee shop operator may determine that sales volume for coffee has not increased at his coffee shop store in the past six months that the spend-and-get coffee shop loyalty program has been implemented. The analysis may provide a comparison of sales volume of the coffee shop of the coffee shop operator against other coffee shops in the area. Given the outcome of the analysis, the coffee shop operator may determine that the spend-and-get coffee shop loyalty program is not cost effective and should be terminated. Alternatively, or in combination, the coffee shop operator may request, via a transmission to the platform 112, that an analysis be done showing sales volume of all spend-and-get loyalty programs involving coffee across a plurality of the merchants 110 within a fifteen mile radius. Thereafter, the coffee shop operator may decide to alter one of the parameter of the spend-and-get coffee shop loyalty program such as by requiring only five purchases of coffee prior to receiving the sixth one free.

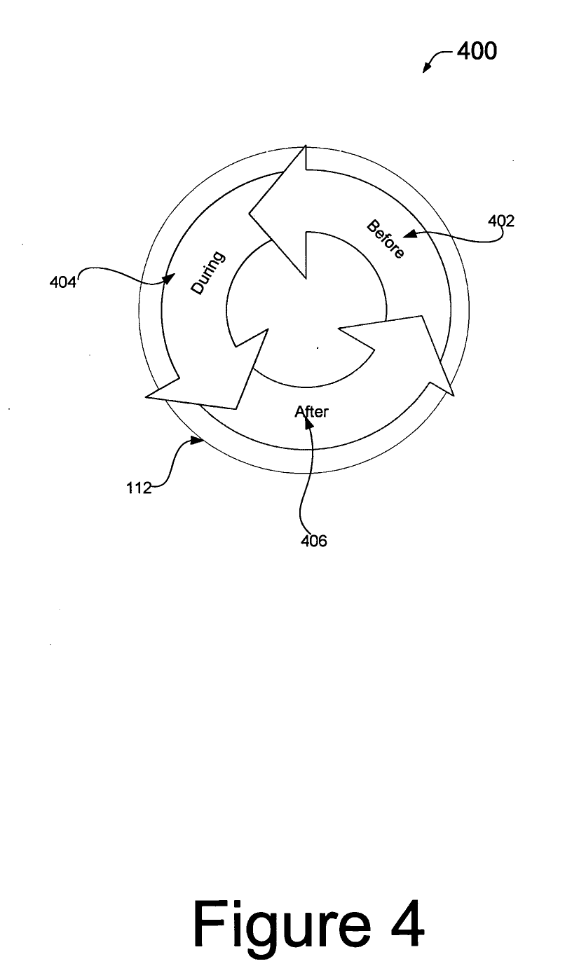

FIG. 4 is a schematic of a transaction lifecycle 400 for the loyalty program 114 including the phases of a Before Phase 402, a During Phase 404, and an After Phase 406. In one embodiment, the platform 112 supports the loyalty program 114 throughout the transaction lifecycle 400.

At the Before Phase 402, the loyalty program 114 may be created using the platform 112. For example, information about the consumer 102 may be analyzed the Before Phase 402 including obtaining one or more transaction files of the corresponding consumers 102, transforming the files into readable form, and segmenting and identifying the potential consumer of the loyalty program 114. Moreover, negotiations can occur with collaborative constituents, such as the issuer 104 or the merchant 110 to construct loyalty program business rules in order to determine what transactions may qualify for the loyalty program 114.

At the During Phase 404, the platform 112 can facilitate information exchange. For example, information in a transaction message associated with a transaction may be relayed to a participant of the loyalty program 114 such as the transaction handler 106 that in turn relays the information in the transaction message to the other participant of the loyalty program 114 via the platform 112. Moreover, the information in the transaction message may be analyzed such as by qualifying and authenticating non-financial data (e.g., authenticating the GUID for the merchant 110).

At the After Phase 406, the platform 112 can facilitate the refinement of the loyalty program 114. For example, the loyalty program 114 can be refined to better meet the needs and intended goals of the participants by evaluating the transaction data of a plurality of the consumers 102 that have participated in the loyalty program 114.

The actions described for each of the Before Phase 402, the During Phase 404, or the After Phase 406, are not limited to a particular phase alone. For example, construction of the loyalty program 114, construction of loyalty program business rules, analysis of information, and negotiation between collaborative constituents, can occur at the Before Phase 402, the During Phase 404, and/or the After Phase 406. For example, at the After Phase 406, a new parameter of the loyalty program 114 can be created. Similarly, actions such as facilitating the exchange of transaction data and analysis of the transaction message can occur at the Before Phase 402, the During Phase 404, and/or the After Phase 406. For example, at the After Phase 406, the information in the transaction message may be analyzed. Moreover, actions such as further qualifying the transaction message, refining the loyalty program 114 and fulfillment calculation and realization can occur at the Before Phase 402, the During Phase 404, and/or the After Phase 406. For example, at the Before Phase 402, the loyalty program 114 may be further refined and the qualifying fulfillment for the loyalty program 114 may occur at the During Phase 404 (e.g., discount at the POS device).

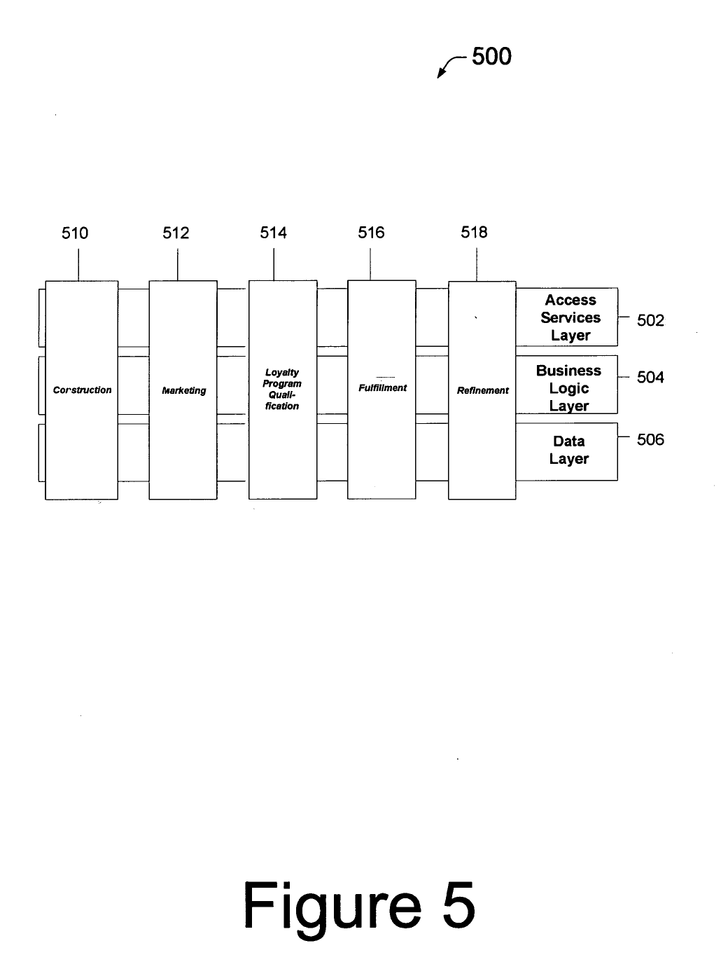

FIG. 5 is a schematic illustrating various layers of the platform 112 that the collaborative constituent may access and the components of the loyalty program 114 that the platform 112 can facilitate.

Several layers can support the platform 112 including an access services layer 502, a business logic layer 504, and a data layer 506. The access services layer 502 of the platform 112 represents the common data interface between collaborative constituents. Via the access services layer 502, collaborative constituents can communicate with one another in a market place type environment. For example, each collaborative constituent may transmit proposals, responses, and/or replies under a predetermined loyalty program rules. The business logic layer 504 is the infrastructure within the platform 112 that supports collaboration between collaborative constituents. For example, the business logic layer 504 may include a server, a database, and a program that can determine whether the transaction of the consumer 102 for the purchase the selected inventory item qualifies for the loyalty program 114 of the merchant 110. The data layer 506 represents transaction and participant data, such as (but not limited to) the information on the collaborative constituents within each corresponding profile of the collaborative constituent.

The collaborative constituents can access the platform 112 to facilitate various components of the loyalty program 114 including: a construction 510, a marketing 512, a loyalty program qualification 514, a fulfillment 516, and a refinement 518 components of the loyalty program 114.

The collaborative constituents may access the platform 112 for the construction 510 component of the loyalty program 114. Through the access services layer 502, two or more of the collaborative constituents can interact to construct the loyalty program 114. The construction 510 of the loyalty program 114 can include: constructing the business case that supports a parameter of the loyalty program 114, posting proposals, negotiating proposals, or identifying potential participants. For example, the collaborative constituent may choose from predetermined parameters developed by the transaction handler 106 prior to the negotiation in constructing the loyalty program 114, negotiating them in isolation or combinations. The collaborative constituent, such as the merchant 110, may transmit proposal containing a parameter that the merchant 110 wishes another of the collaborative constituents to accept (e.g., express favor to), identify the consumer 102 such as a consumer group desired to become a recipient of the proposal, or elect to receive information from the data layer 506 regarding the consumer 102.

Through the use of the data layer 506, collaborative constituents can construct the loyalty program 114 targeting the consumer 102 and the product purchased. For example, the loyalty program 114 can be a loyalty program that utilizes high level product information (e.g., a SKU) as a trigger for the loyalty program business rule. The trigger can be product category specific “music players,” or product line specific such as iPod® Nano, or a manufacturer such as Apple Computer, Inc. (e.g. “ten percent off all Apple Computer® products if you use your Wells Fargo® credit card.”). Consequently, the collaborative constituent involved in different levels of the chain of distribution such as a manufacturer, a distributor, a retailer, or the merchant 110, can better target the loyalty program 114 promotion via the platform 112.

The collaborative constituents may access the platform 112 for the marketing 512 component of the loyalty program 114. The marketing may include sending a marketing transmission containing information based in part on the remaining parameter for the loyalty program 114. The third transmission may be addressed to at least one of the consumers 102, such as one of the consumers 102 in the set of eligible consumers 102, selected based on the criteria proposed by the merchant 110 or negotiated as part of the negotiated agreement. For example, the third transmission may be sent to a wireless cellular telephone of the one of the selected consumer 102 within the set of eligible consumers 102 including the offer of $10.00 U.S. credit from a barber shop along with a confirmation code for the offer that an operator at the barber shop may verify at the time of purchase.

The collaborative constituent may access the platform 112 for the loyalty program qualification 514 component of the loyalty program 114. The loyalty program business rules may be applied to the transaction data associated with a purchase of the consumer 102 to determine if the purchase qualifies for the reward associated with the loyalty program 114. The transaction data may include data that populate a field within the transaction message associated with the transaction such as a code for the merchant 110 that is nonunique, the merchant unique identifier such as the GUID for the merchant 110, an account number of the consumer 102 within the transaction processing system, and information about the product or service purchased, a code for the loyalty program 114, for example.

A determination can be made as to whether the transaction is eligible for the reward of a loyalty program, such as the loyalty program 114, by using a GUID matching algorithm. The GUID matching algorithm may facilitate determining whether the merchant 110, the account of the consumer 102, the inventory item purchased, or a combination of the forgoing satisfy a condition of the loyalty program business rule by matching the transaction data, such as the GUID for the merchant 110, with corresponding GUIDs stored in the loyalty program database. Parameters of the loyalty program business rule may determine how many components of the transaction data should be matched with the corresponding GUIDs in the loyalty program database to satisfy becoming eligible for the reward.

For example, the loyalty program business rule may have parameters indicating that the merchant 110 must be one of participants of the loyalty program 114 and the transaction must be made payable upon the account within the transaction processing system that is issued to the consumer 102 in order for the transaction to be eligible for the reward of the loyalty program 114. The determination of the eligibility may entail matching both the account GUID and the GUID for the merchant 110 characterizing the transaction against a plurality of account GUIDs and merchant GUIDs respectively in the loyalty program database.

The consumer 102 need not present the coupon in order to receive the promotion. For example, fields within the transaction message may be used to identify promotions and the consumer 102 as a member of the set of eligible consumers receiving the promotion thereby automatically informing the merchant 110 at the POS device that the promotion should be honored for the consumer 102. For example, the transaction handler 106 may be in communication with the platform 112 during the authorization phase of the transaction involving the printer toner. The transaction handler 106 may send the portions of the transaction message containing the account number of the account of the consumer 102 and an identification information of the merchant 110 to the platform 112. The program accessible via the platform 112 may use the account number to check to see if the consumer 102 is a member of the eligible consumer set receiving the promotion for a free pack of paper. If the consumer 102 did receive the promotion, a transmission may be formed and addressed to the transaction handler 106 indicating that the consumer 102 should receive the benefits of the promotion. The transaction handler 106, in turn, may address a message to the device 205 that the promotion should be honored for the consumer 102. The merchant 110 may then offer the reward to the consumer 102 in the fulfillment 516 component of the loyalty program 114.

The collaborative constituent may access the platform 112 for the fulfillment 516 component of the loyalty program 114. For example, once a transaction, or set of transactions qualify for fulfillment of the loyalty program 114, the transaction handler 106 can facilitate fulfillment of that reward in accordance with one of the remaining parameter for the loyalty program 114. For example, if the loyalty program 114 is the coffee shop spend-and-get loyally program, the transactions that qualify for the coffee shop spend-and-get loyally program can be electronically tracked and a message sent to a cell phone of the consumer 102 that the consumer 102 can receive a free cup of coffee the next time the consumer 102 goes to the coffee shop operator's store. The transaction handler 106 may take fulfillment actions including: calculate a the value of a promotion; awarding bonus points or miles; facilitating providing a statement credit, cash back value, or discount value to the participant of the loyalty program (e.g., the consumer 102); forwarding the part of the transaction data regarding the fulfillment (e.g., the calculated value of the promotion) to another of the collaborative constituent or to a support group such as a third party having a contractual obligation with the collaborative constituent. The fulfillment actions can occur in real time, as part of the clearing and settlement process, or sometime thereafter, for example.

The fulfillment 516 component may entail changing the cost of an amount that is made payable on an account involved in the transaction based on a value of the reward for the loyalty program 114 or providing value to the consumer 102 associated with the account involved in the transaction, such as a free cup of coffee.

Information regarding the derived reward may be transmitted to one of the collaborative constituents. For example, the value of the derived reward, the date the derived reward was redeemed, the time the derived reward was redeemed, past reward that have been derived for the loyalty program 114 can be included in a formed transmission addressed to the merchant 110 corresponding to the merchant GUID within the transaction data.

The collaborative constituents may access the platform 112 for the refinement 518 component of the loyalty program 114. The collaborative constituent, can access tools available at the platform 112 such as reporting, metrics and analytical tools, enabling the collaborative constituent to get statically generated analysis, dynamically generated analysis, or review forward looking promotional calendars to refine marketing strategies of the collaborative constituent. For example, the merchant 110 may access the platform 112 to evaluate a performance of the loyalty program 114. The merchant 110 may create reports via statistical software accessible at the platform 112 and determine the degree that the consumer 102 or any group of the consumers 102 that are targeted as participated in the loyalty program 114 have changed the purchasing behavior of the consumer 102 based on parameters including: demographics, SKU numbers, store locations, seasonal variances, or consumer habits of buying related commodities such as shoes with socks. The merchant 110 may decide to refine a range of the consumers 102 that the merchant 110 has targeted or promotions in the loyalty program 114 by continuing the negotiation process, such as steps 302 through 314 of FIG. 3.

Although illustrated in a progressive manner, the transaction components of the following can follow any order or be concurrent: the construction 510, the marketing 512, the loyalty program qualification 514, the fulfillment 516, and the refinement 518 components. For example, the refinement 518 component of the loyalty program 114 may occur during the marketing 512 component such as by narrowing the group of the consumers 102 that are targeted, the fulfillment 516 component may occur during the transaction component program qualification 314 component such as when the consumer 102 receives a discount during a purchase, and the marketing 512 can occur during the fulfillment 516 component such as providing the consumer 102 with a coupon for the next purchase. Other combinations are readily conceivable to a person of ordinary skill in the art.

A computer program product can be configured to enable a computer to perform predetermined operations facilitating construction, marketing, loyalty program qualification, fulfillment, and refinement of the loyalty program 114. The computer program product can be accessible from a computer readable medium bearing the software instructions for the methods herein described, such as the method 300 beginning at step 302.

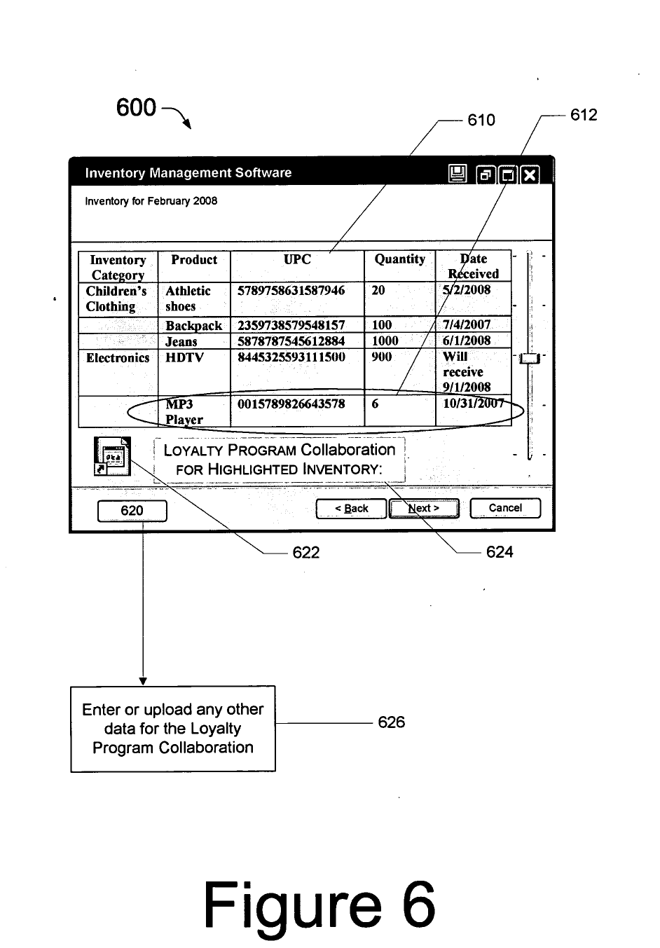

Referring to FIG. 6, a GUI 600 associated with the IMS is illustrated through which the merchant 110 may connect to the platform 112. The GUI 600 may facilitate access to a database containing information about the inventory of the merchant 110, such as through a chart 610. The merchant 110 may select one of the inventory items in the inventory for which the merchant 110 wishes to create a proposal including the offer to be submitted in a transmission to one of the collaborative constitutes via the platform 112.

The GUI 600 may have various navigational elements accessible via graphical icons, such as an icon 620 or a loyalty program collaborative offer icon 622. When selected, the icon 620 or the loyalty program collaborative offer icon 622 may navigate a user of the GUI 600 to a different GUI, a different software application such as a word processor, a Uniform Resource Locator address, or a pop up data entry window such as a data entry window 626. Information about the offer or the loyalty program 114, such as the parameters of the loyalty program 114, may be entered by the user of the GUI 600 into the data entry window 626. By way of example, Information about the offer or the loyalty program 114 may include: an identification of one of the collaborative constituents, an identification of a location for which the offer is to be made valid; an identification of a date range during which the offer is to be considered valid; an identification of one of the collaborative constituent to collaborate on the parameters of the loyalty program having the offer for the selected inventory item; an image file that can be used in an ad targeted to the consumer; or a type of an account upon which the transaction for the selected inventory item from can be made payable.

The loyalty program collaborative offer icon 622 may be a link to the platform 112. For example, the loyalty program collaborative offer icon 622 may be a hyperlink to a URL address associated with the platform 112. The merchant 110 may connect to the platform 112 by selecting the loyalty program collaborative offer icon 622 such that the merchant 110 can submit transmissions to the platform 112 subsequent to selection of the loyalty program collaborative offer icon 622. Moreover, if the merchant 110 has selected the inventory item for which the merchant 110 intend to create a proposal of the offer, data on the inventory item may automatically be included in one of the transmissions to the platform 112. The data on the selected inventory item may automatically populate a field within a message that is formed during or after the merchant 110 selects the loyalty program collaborative offer icon 622. Similarly, the identifier of the merchant 110 may automatically populate a field in the new GUI. For example, the merchant 110 may manually select the inventory item “MP3 Player” as a potential inventory item that the merchant 110 would like to propose as part of an offer within the loyalty program 114. Upon selecting the loyalty program collaborative offer icon 622, a new GUI may be rendered, such as an offer management screen, upon the monitor of a computer of the merchant 110. The data on the selected inventory item or the merchant identifier may automatically be entered to input fields of the new GUI. Consequently, the selection of the loyalty program collaborative offer icon 622 can serve at least two purposes: connecting to the loyalty platform 112 and transmitting parameters of the offer, such as the selected inventory or the GUID of the merchant 110, to the loyalty platform 112.

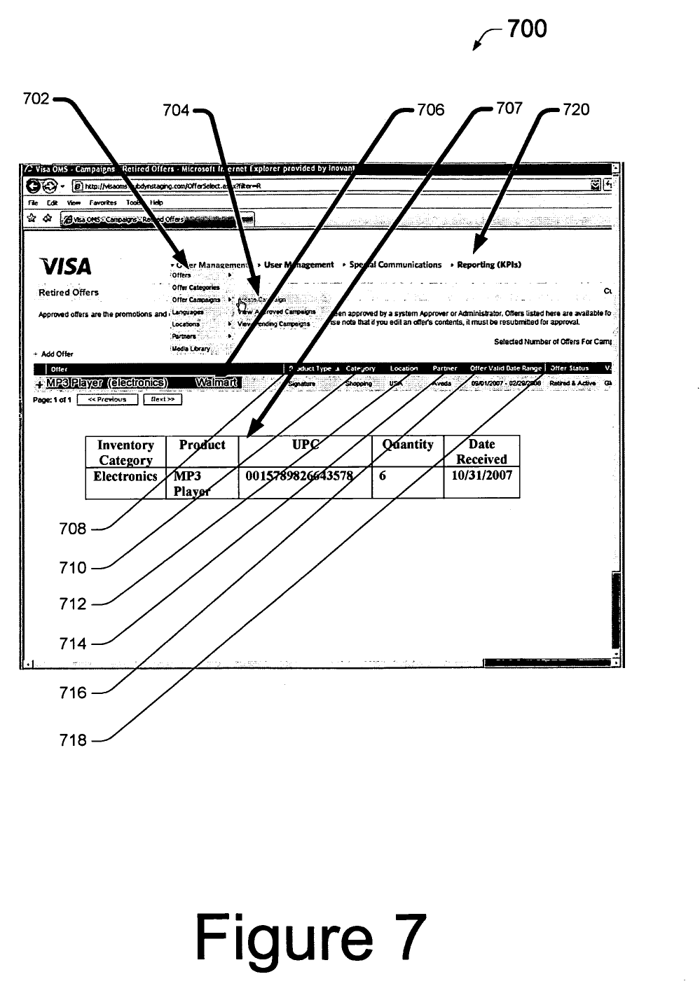

FIG. 7 refers to an exemplary offer management screen 700 through which offers for the consumer 102 can be designed and implemented. Reference numeral 702 refers to an icon that can be activated to create an offer, as well as offer categories and offer campaigns. Reference numeral 704 shows that the highlighted phrase “Create Campaign” has been activated so that an advertising campaign to make offers to selected consumers 102 has been initiated. Reference numeral 706 refers to a specific offer that has already been created titled “MP3 Player.” Reference numeral 708 shows the type of product that the offer is for, in this case a ‘Visa Signature’ card. Reference numeral 710 shows the category of the offer which is for a particular discount or special offer for shopping for a good or service. Reference numeral 712 shows that the location for which the offer is active is to be for the United States. Reference numeral 714 shows that a partner is the collaborative constituent that has been labeled “AVEDA.” FIG. 7 shows retired offers as seen in offer status icon 718 on screen 700.

Reference numeral 716 shows that the offer will be valid to be exercised by selected consumers 102 between Sep. 1, 2007 and Feb. 29, 2008. Reference numeral 718 shows whether the offer is retired and/or active under the offer status icon seen in offer management screen 700. Reference numeral 720 shows an icon that can be activated to show the performance indicators relating to different offers that have been made to the offer management system.

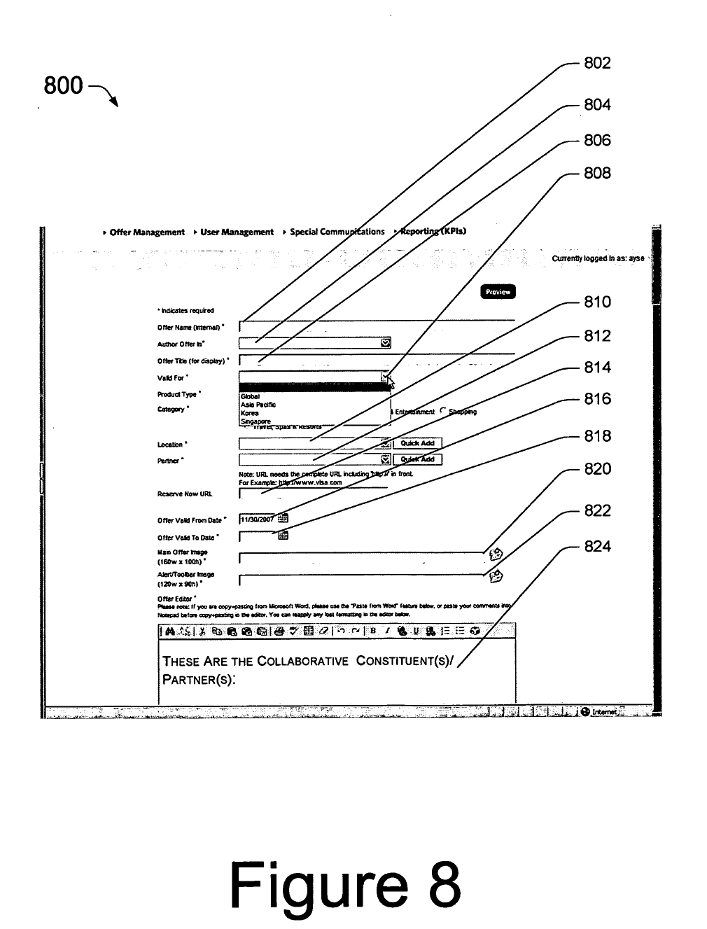

FIG. 8 shows a data input screen 800 in which an offer can be created. Various fields are open for input by data entry in order to create an offer to be offered to the selected consumers 102, who are otherwise accountholders. Each of the various fields may be automatically populated via information entered into the GUI 600.

Field 802 provides a field where the name of the offer can be specified. Field 804 is for input of the author of the offer and input Field 806 is for input of the title of the offer. Pull down menu 808 is for the selection of a geographic or political location where the offer is to be made valid. As seen in the pull down menu 808, the selections include Global, Asia/Pacific, Korea, and Singapore. Input Field 810 is for the location where the offer is to be valid. In this case, the location can be a particular city within the geographic or political location as selected from pull down menu 808. Input Field 812 is for a particular partner (e.g., the collaborative constituent) that will be partnering on the offer. Input Field 814 is a place where a URL can be input that refers to further information about the offer, such as where an online purchase can be immediately made or reserved by going to a certain website where the offer can be immediately acted upon by a cardholder. An offer valid date is seen at reference numeral 816 and the offer termination date is seen at an Input Field 818, where the respective fields can be input through use of a calendar icon, and where a pop-up for a particular calendar can be seen and the date clicked on that is to be selected for the input field. Reference numerals 820 and 822 are for the input of images to be offered in conjunction with the textural offer being made. These images can be an ad targeted to the selected consumer 102 who will be likely to make a purchase through the offer management system as disclosed in various implementations herein. The offer editor is an input field 824 allowing a user to make text input about the offer for further reference.

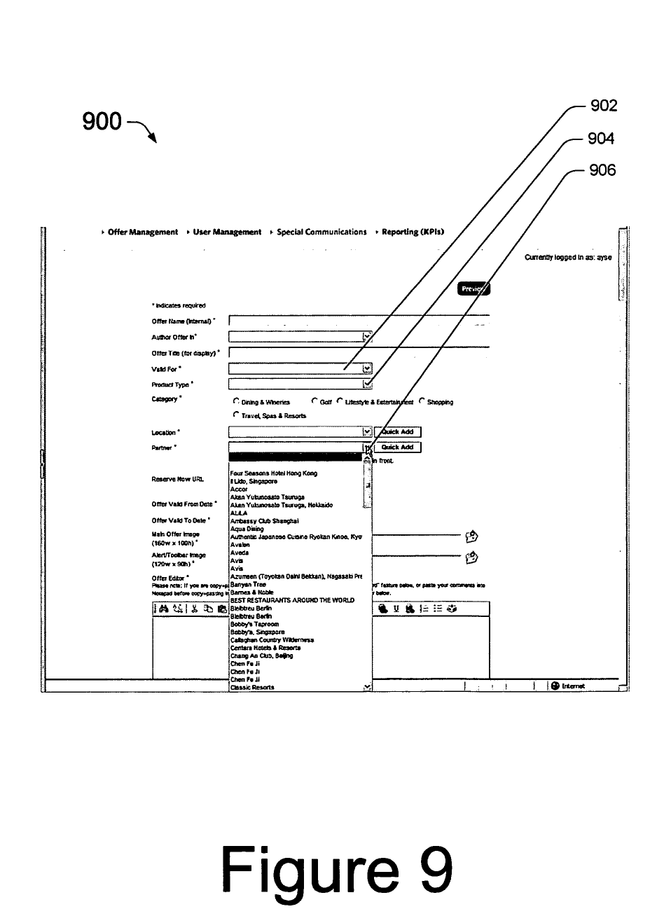

FIG. 9 is a continued explanation of the input screen seen in FIG. 8 where the input screen is depicted at reference numeral 900. In input screen 900, a “Valid For” field 902 has been explained previously at reference numeral 808 seen in FIG. 8. At reference numeral 904, an input field is given for a product type. The product type may be a different type of account or credit vehicle that is offered by a transaction handler 106 and/or an issuer 104. Thus, the product type might be an American Express® Gold Card, American Express® Platinum Card, a Visa® Signature Card, a Visa® Infinity Card, a MasterCard® Business Purchase Card, etc. Input Field 906 seen on screen shot 900 shows a partner from a pull down menu which can be selected. As can be seen, the pull down menu shows a variety of the merchants 110 that would like to make offers to the consumer 102. By way of example, these offerors include AVEDA, Banyan Tree, Barnes & Noble, Four Seasons Hotel Hong Kong, etc.

The input fields shown in input screens seen in FIGS. 8 and 9 are illustrative. Other input fields may include:
Merchant Name:
Originator's Contact:
Date of Request:
Description of project:
What are the business objectives?
Describe the marketing environment: names of competitors, current attitudes of target audience(s), etc.:
Provide logo, if applicable
What are the business objectives?
What are the main benefits of this project to each audience, in order of priority?
What is the key message we want to communicate to each audience?
What do we want each audience to do or believe as a result of this project?
What Transaction Processor materials would provide background information? (Please attach.)
Additional information or direction:
What information would help Marketing Communications and Agency determine the copy tone or style for the overall project? Do certain components need a different tone?
What type of copy input will be provided (copy points, brochures, Uniform Resource Locators “URLs”)?
What information would help Marketing Communications and Agency determine the design tone or style for the overall project?
Are there any print production issues or requirements for this project? Offer Period:
Offer Redemption Process (e.g. coupon, statement credit). (If using bar codes, specify type, positioning, size and other requirements here).
Will offer be available online?
If offer will be available online, provide online code requirements. Attach additional spreadsheet if needed.
Will offer be available via catalog?
If offer will be available via catalog, provide code and requirements.
Attach additional spreadsheet if needed.
Creative branding guidelines and considerations. If branding guidelines are available, please provide here as well.
Delivery method
   Letter with coupon
   Buckslip
   Insert (if doing an insert, please provide size and specs)
   e-mail
   mobile
Cashier instructions (to be placed on coupon):
Merchant messaging (if applicable):
Phone number and/or URL for offer:
Who will review each round of creative?
How many days should we schedule for originator's group to review rounds if different than a normal transaction handler review time?
List the primary and secondary target audience(s).
Potential audience/segments:
Will there be a customer suppression list? If so, please provide description and date this will be available (see Customer Suppression File Format)
Will a Merchant Store Location List be provided for geo-coding purposes (if applicable)?
Please describe any targeting requirements:
Location/Geographies:
Type of program output:
   Qualified Transactions Only
   Calculated Awards
   Discounts
   Bonus Points
   Statement Credits
   Discount File
Transaction Purchase Start Date:
Transaction Purchase End Date:
Cardholder Selection Criteria
If transactions will be qualified based on cardholder information, please complete this section.
Transactions will be identified at the following level:
   an Issuer code
   Issuer Card Range
   Issuer Bank Identification Number (BIN)
   Participating/Eligible Cardholder List
Approximate number of participating/eligible cardholders:
Cardholder files will be updated with the following frequency:
   Daily
   Weekly
   Monthly
   Other—Please specify below:
Transaction files will be delivered with the following frequency:
   Daily
   Weekly
   Monthly
   At the end of the promotion period
   Other—Please specify below:
Selection Criteria
If transactions will be qualified based on specific information, please provide selection criteria.
Transactions will be qualified based on (check one):
   Acquirer BIN(s)
   Merchant Category Codes
   List of Specific Participating Merchants
   Merchant Identifiers
   Merchant GUID
   Other (specify);
Additional Transaction Selection Criteria
Please briefly describe any additional targeting qualification criteria that must be applied.
Option Limits
Applies only if calculating awards.
Program Limits:
   Money Unit amount
   Points
   Number of Awards
Please specify below:
Option Limits
Applies only if calculating awards.
Cardholder Limits:
   Money Unit amount
   Points
   Number of Awards
Bonus Processing:
Please list the bonus point ratio here.
Statement Credits
How is the program funded?
   Merchant funded
   Issuer funded
   Transaction Processor funded
   Third party loyalty provider
Funding BIN
Please specify funding BIN for statement credit processing

Yet another exemplary list of input fields may include:
1. Please select whether your promotion(s) should be provided to:
   a. Consumers
   b. Small Businesses
   c. Large corporations
   d. Government entities
   e. Other commercial entities
   f. A combination of the foregoing.
2. Please select the objective for your promotion: (tips/templates on ads/promotions that work for the merchant's stated industry may be suggested—the tips/templates will change based upon objectives and the issuer 104 can edit the parameters and copy etc.)
   a. Reward existing customers
   b. Increase spend from existing customers
   c. Obtain sales from new customers
   d. Would you like assistance in creating your promotion?
3. Provide some targeting parameters:
   a. Geographical:
      (i) Region
      (ii) City
      (iii) Draw your own borders
      (iv) Within X miles of your address
   b. Check the business types that may buy from you
   c. Include people from previous promotions?
   d. Would you like to target customers who spend (include spend bands)
   e. Would you like to target customers who are similar in characteristics to your existing customers?
4. How would you like your promotion to appear?
   a. Statement credit
   b. Coupon
   c. Point of Service (POS)
   d. Email
   e. Mobile
   f. Statement insert for bank
   g. Visa or bank promotion site
5. When would you like your promotion to first appear?
6. What is the promotion period for your promotion?
7. What type of reporting do you require?
8. Pricing
   a. What is your budget? (the merchant 110 enters budget and system provides approximate number of cardholders addressed based upon parameters selected)
   b. Enter # of cardholders desired (system calculates pricing based upon parameters selected)

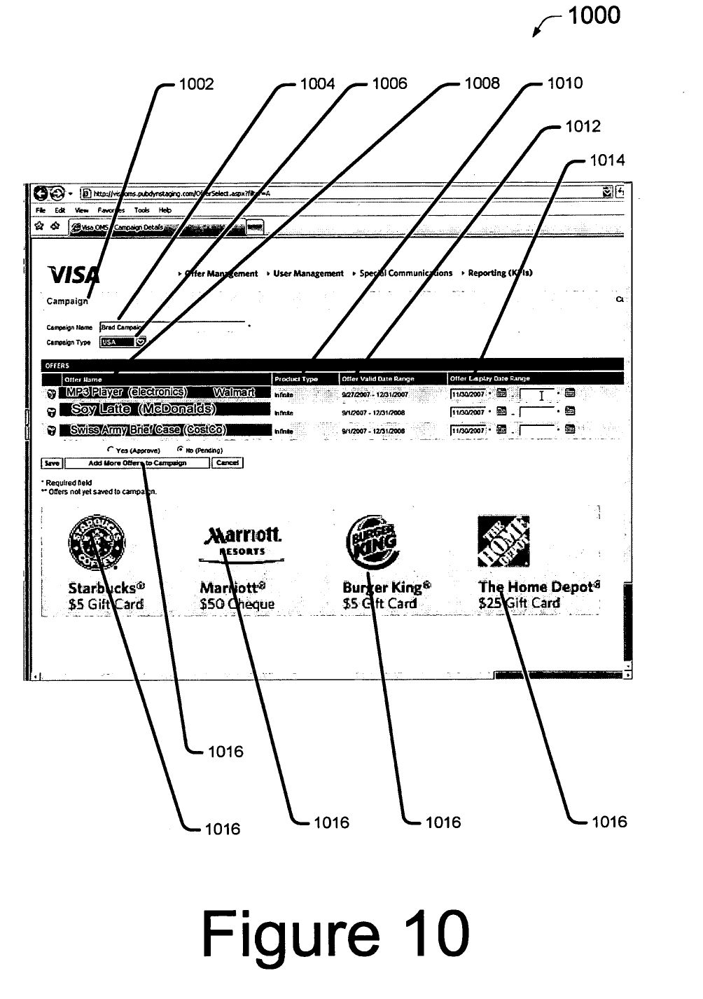

FIG. 10 shows a “Campaign” screen 1000 as indicated at reference numeral 1002. The name of the campaign is “Brad Campaign” as seen at reference numeral 1004. At reference numeral 1006, the type of campaign is shown by way of pull down menu, and specifically refers to the geographic region, in this case being “USA.” At reference numeral 1008, the various offers within the Brad Campaign are seen, in this case three different offers including MP3 player, Soy Latte, and Swiss Arm Brief Case are illustrated. At reference numeral 1010 the product type is shown, in this case being the Visa® Infinity Card. At reference numeral 1012, the date range which each the offer in the campaign is to be considered valid, including both a beginning date and an ending date are illustrated. At reference numeral 1014, a display illustrating the date ranges by which offers will be displayed to the consumer 102 on their branded desktop application. As such, the display date range may be different than the offer validation range. That is, the entries under reference numeral 1012 may be different from the entries under reference numeral 1014. Reference numeral 1016 allows a user to activate a “Add More offers” function so that additional offers can be added under the Offers portion of the data entry screen 1000, specifically under reference numeral 1008.

To illustrate, the merchant 110 may be a cruise line operator. The cruise line operator may wish to create multiple offers within the loyalty program 114. The cruise line operator may select multiple inventory items using the GUI 600 that each automatically uploaded onto the management screen 700 and automatically populate fields within the data input screens 800 and 900. For example, the cruise line operator may select multiple of the inventory items such as: a tour to be given to the consumer 102 that is a traveler on a ship within the cruise line, jewelry at a jewelry shop located at a docking harbor of the ship, or coffee at a Starbucks® kiosk located on the ship. The cruise line operator may select distinct collaborative constituents for each of the multiple inventory items, thereby concurrently negotiating with multiple collaborative constituents for the multiple offers within the loyalty program 114.

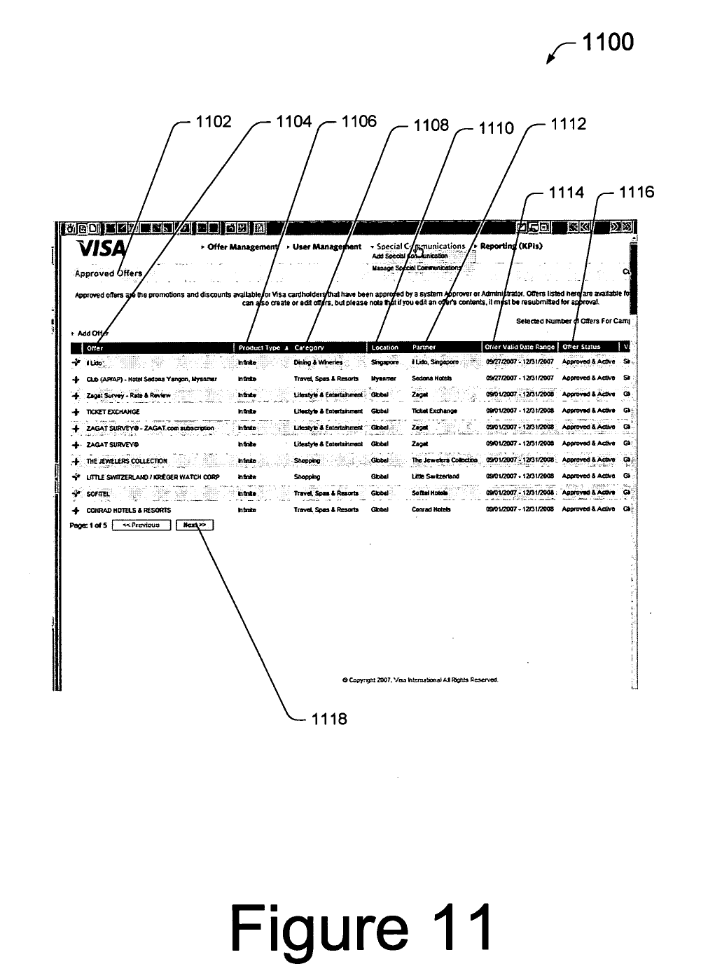

FIG. 11 shows a list of approved offers as indicated at reference numeral 1102. Reference numeral 1104 shows the offers seen as a list below the caption “Offer.” Reference numeral 1106 shows the product type, reference numeral 1108 shows the list of categories, reference numeral 1110 shows the locations where the offers will be made, reference numeral 1112 shows the partners (e.g., collaborative constituents) making the offers in conjunction with the transaction handler 106 (in this case, the transaction handler 106 displayed is ‘Visa’), reference numeral 1112 shows the dates by which the offer will be valid and reference numeral 1112 shows the status as being approved and active in the list below reference numeral 1116. Reference numeral 1118 shows an operation that can be activated so that the operator of the input screen can continue to the next screen.

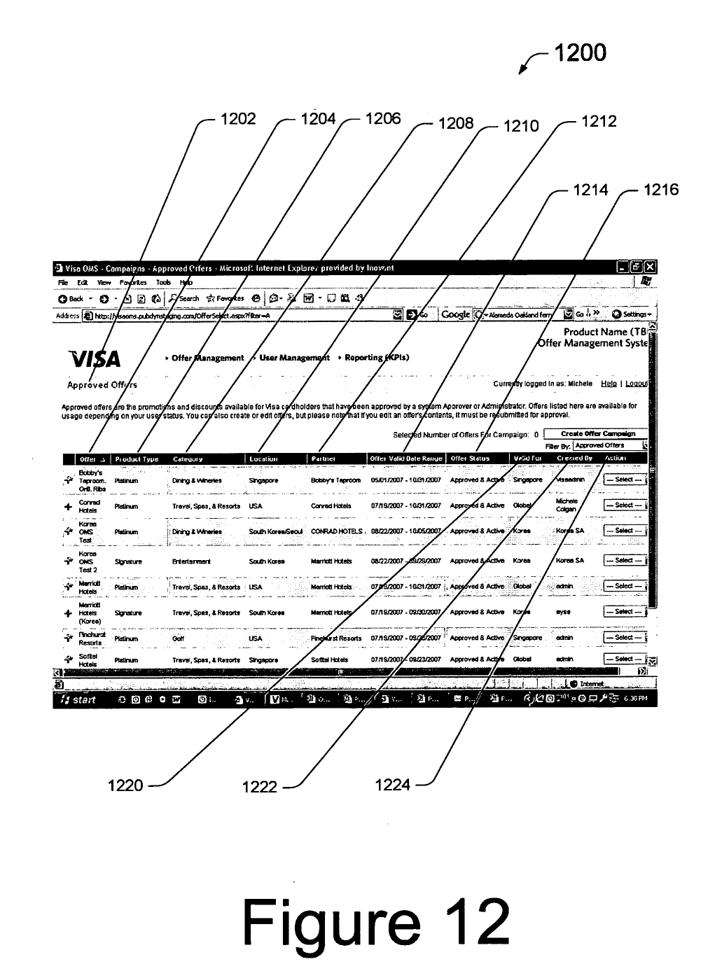

FIG. 12 shows a screen 1200 depicting aspects of approved offers as indicated reference numeral 1202. At reference numeral 1204, each offer is characterized by the entity that is making the offer. At reference numeral 1204, the product type is listed. At reference numeral 1208, the categories of each respective offer is shown. The location at which each offer is being made is indicated in the list below reference numeral 1210. At reference numeral 1212, the partner making the offer is listed, respectively, with each offer. The partner 1212 may be also referred to in the title of the offer at 1204. The date range during which the offer is valid is seen at reference numeral 1212, and the status of each offer is seen below the title at reference numeral 1216. Reference numeral 1220 shows the location for which the offer is valid, and reference numeral 1222 shows the creator of the offer within the offer management system. An indicator as to whether or not any new action has to be taken with respect to each offer is seen below the title “Action” at reference numeral 1224.

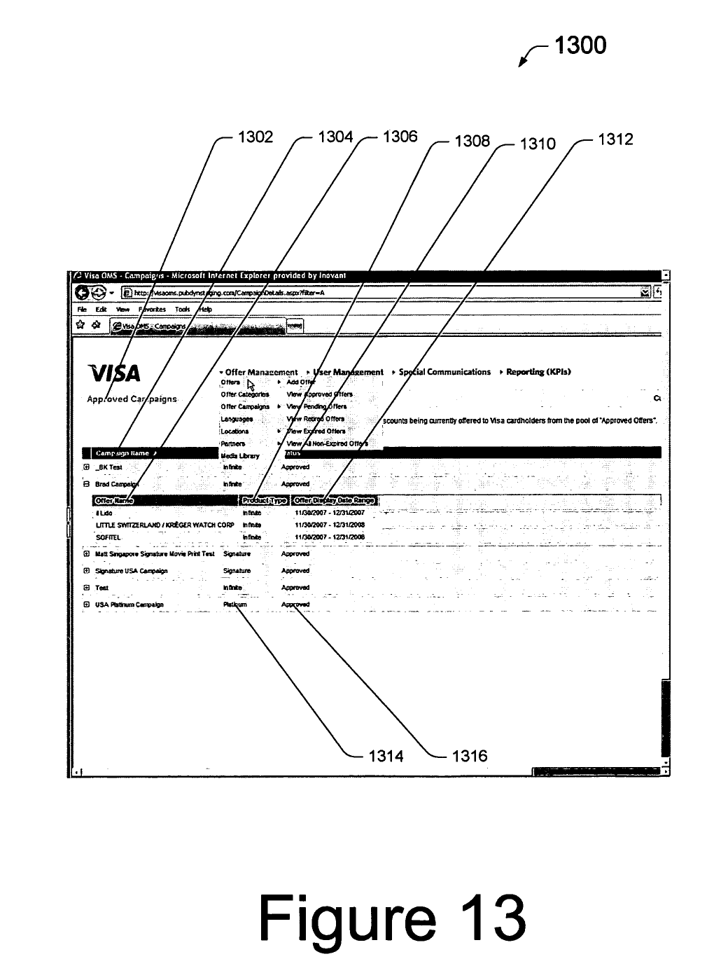

FIG. 13 shows a screen shot 1300 for approved campaigns (e.g., offers) as indicated at reference numeral 1302. The campaigns have been given names under the banner “Campaign Name” at reference numeral 1304. Here it is seen that there are two campaigns: “BK Test” and “Brad Campaign”. At reference numeral 1306, the offer name banner is listed and shows several offers underneath including Il Lido, Little Switzerland, SOFITEL, Mat Singapore Signature Move Print Test, Signature USA Campaign, Test, and USA Campaign Platform. Reference numeral 1308 shows a banner “Product Type” which shows the type of card for which the offer is being made, which here is the “Infinite” product type. Also under reference numeral 1308 are the product types Signature and Platinum. Reference numeral 1308 shows the status banner which indicates that the campaign has been approved as shown below reference numeral 1310. Reference numeral 1314 corresponds to reference numeral 1308 to indicate the product type for each of the offer names, and reference numeral 1316 corresponds to reference numeral 1310 to indicate that an offer is specifically approved.

### The Transaction Processing System

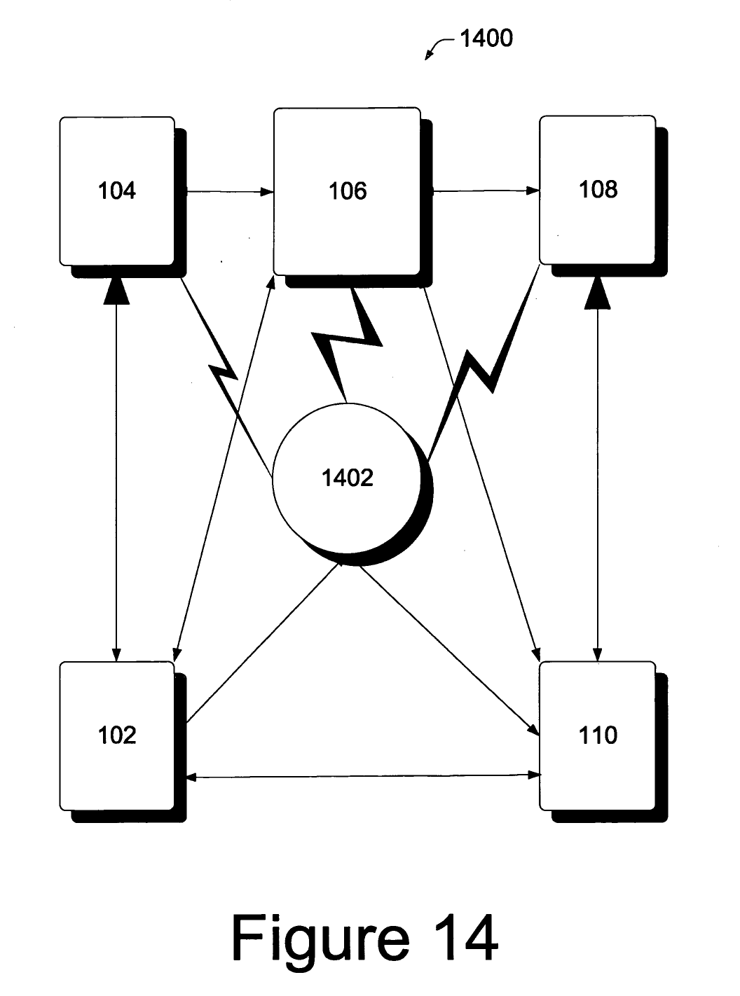

FIG. 14 illustrates a block diagram of an exemplary transaction processing system 1400 within which the exemplary environments, methods, and process of FIGS. 1-13 may be practiced. As will be readily understood by persons of ordinary skill in transaction processing systems, a transaction such as a payment transaction in a transaction processing system can include participation from different entities that are each a component of the transaction processing system. The exemplary transaction processing system 1400 includes the issuer 104; the transaction handler 106; the acquirer 108; the merchant 110; and the consumer 102. The acquirer 108 and the issuer 104 can communicate through the transaction handler 106. The merchant 110, such as the utility provider, may utilize at least one POS device that can communicate with the acquirer 108, the transaction handler 106, or the issuer 104. Thus, the POS device is in operative communication with the transaction processing system 1400.

Typically, a transaction begins with the consumer 102 presenting an account number of an account (e.g., non-credit account) such as through the use of a computer terminal or a portable consumer device 1402 to the merchant 110 to initiate an exchange for a good or service. The consumer 102 may be an individual or a corporate entity. The consumer 102 may be an account holder of the account issued by the issuer 104 such as a joint account holder of the account or a person having access to the account such as an employee of a corporate entity having access to a corporate account. The portable consumer device 1402 may include a payment card, a gift card, a smartcard, a smart media, a payroll card, a health care card, a wrist band, a machine readable medium containing account information, a keychain device such as the SPEEDPASS® commercially available from ExxonMobil Corporation or a supermarket discount card, a cellular phone, personal digital assistant, a pager, a security card, a computer, an access card, a wireless terminal, or a transponder. The portable consumer device 1402 may include a volatile or a non-volatile memory to store information such as the account number or a name of the account holder.

The merchant 110 may use an acceptance point device, such as a POS device, to obtain account information, such as the indicator for the account (e.g., the account number of the account), from the portable consumer device 1402. The portable consumer device 1402 may interface with the POS device using a mechanism including any suitable electrical, magnetic, or optical interfacing system such as a contactless system using radio frequency, a magnetic field recognition system, or a contact system such as a magnetic stripe reader. The POS device sends a transaction authorization request to the issuer 104 of the portable consumer device 1402. Alternatively, or in combination, the portable consumer device 1402 may communicate with the issuer 104, the transaction handler 106, or the acquirer 108.

The issuer 104 may submit an authorize response for the transaction via the transaction handler 106. Authorization includes the issuer 104, or the transaction handler 106 on behalf of the issuer 104, authorizing the transaction in connection with instructions of the issuer 104, such as through the use of the loyalty program business rules. The transaction handler 106 may maintain a log or history of authorized transactions. Once approved, the merchant 110 can record the authorization and allow the consumer 102 to receive the good or service.

The merchant 110 may, at discrete periods, such as the end of the day, submit a list of authorized transactions to the acquirer 108 or other components of the transaction processing system 1400 for clearing and settling. The transaction handler 106 may compare the submitted authorized transaction list with its own log of authorized transactions. If a match is found, the transaction handler 106 may route the clearing and settling request from the corresponding acquirer 108 to the corresponding issuer 104 involved in each transaction. Once the acquirer 108 receives the payment of the transaction from the issuer 104, it can forward the payment to the merchant 110 less any transaction costs, such as fees. If the transaction involves a debit or pre-paid card, the acquirer 108 may choose not to wait for the initial payment prior to paying the merchant 110.

There may be intermittent steps in the foregoing process, some of which may occur simultaneously. For example, the acquirer 108 can initiate the clearing and settling process, which can result in payment to the acquirer 108 for the amount of the transaction. The acquirer 108 may request from the transaction handler 106 that the transaction be cleared and settled.

It should be understood implementations can be in the form of control logic, in a modular or integrated manner, using software, hardware or a combination of both. The steps of a method, process, or algorithm described in connection with the implementations disclosed herein may be embodied directly in hardware, in a software module executed by a processor, or in a combination of the two.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A user interface comprising:
means for inputting data;
a menu including a plurality of selectable inventory items of a merchant;
an inventory selection region for receiving a selection from the means for inputting data of one said inventory item from the menu; and
a loyalty program collaborative offer icon, wherein:
the means for inputting data is operable with the loyalty program collaborative offer icon to activate a function of an application executing on a client that addresses a request to a web service to initiate a loyalty program collaboration on a loyalty program having an offer on the selected one said inventory item from the menu; and
the request includes:
the selected one said inventory item from the menu; and
an identifier for the merchant, wherein the menu, the inventory selection region, and the loyalty program collaborative offer icon are rendered to a display of the client by the executing application.

2. The user interface as defined in claim 1, wherein the identifier is a globally unique identifier (GUID) unique among collaborative constituents that collaborate, by use of the loyalty program collaboration of the web service, on terms and conditions of a plurality of said offers within a plurality of said loyalty programs.

3. The user interface as defined in claim 1, wherein:
the offer is for a transaction that is payable upon an account issued by an issuer to a consumer;
the transaction is between the consumer and the merchant; and
the request further includes an identification of a collaborative constituent to collaborate, by use of the loyalty program collaboration of the web service, on terms and conditions of the offer for the selected one said inventory item from the menu.

4. The user interface as defined in claim 1, wherein:
the loyalty program collaboration of the loyalty program occurs between collaborative constituents that are each selected from a group consisting of an issuer, an acquirer, the merchant, a manufacturer of the selected one said inventory item from the menu, a transaction handler, and combinations thereof;
the transaction handler processes a plurality of transactions each characterized by one said merchant and one said consumer engaging in one said transaction payable upon a corresponding said account that one said issuer has issued to the one said consumer; and
the one said merchant submits the transaction to one said acquirer for processing by the transaction handler who requests one said issuer to obtain payment for the one said transaction from the corresponding said account, and wherein the one said issuer forwards the payment to the transaction handler who forwards the payment to the one said acquirer to pay the one said merchant for the one said transaction.

5. The user interface as defined in claim 1, further comprising an offer parameters selection region for receiving a parameter selection using the means for inputting data, the parameter selection being selected from the group consisting of:
an identification of the geography for which the offer is to be made valid;
an identification of a date range during which the offer is valid;
an identification of a collaborative constituent to collaborate, by use of the loyalty program collaboration of the web service, on terms and conditions of the offer for the selected one said inventory item from the menu;
an image file that can be used in an ad targeted to a consumer;
a type of an account upon which a transaction for the selected one said inventory item from the menu can be made payable; and
a combination of the foregoing.

6. The user interface as defined in claim 1, wherein the application executing on the client is further configured to access a database containing inventory data pertaining to the plurality of selectable inventory items.

7. The user interface as defined in claim 1, wherein each said inventory item is selected from the group consisting of:
a good or service that the merchant has sold to a consumer in the past;
a good or service that the merchant has available for sale; and
a good or service that the merchant can make available for sale in the future.

8. A computer-implemented method of collaborating among collaborative constituents to develop a loyalty program within a transaction processing system, the computer-implemented method comprising:
rendering via a graphical user interface:
a menu of a plurality of inventory items of a merchant; and
a loyalty program collaborative offer icon corresponding to a hyperlink for an address of a host computer;
and
upon receiving a selection of the hyperlink and a menu selection of one said inventory item from the menu:
forming a request and a proposal for delivery to the host computer, wherein:
the request includes:
the selected said inventory item; and
an identifier for a merchant;
the proposal includes:
an address of at least one collaborative constituent in accordance with a first workflow identifying a predefined order thereof; and
parameters for a loyalty program including an offer to a consumer to conduct a transaction with the merchant for the menu selection, wherein:
the consumer is to receive a reward upon:
conducting the transaction; and
satisfaction of a condition of the reward;
and
the transaction is made payable upon an account that is issued by an issuer to the consumer;
receiving a response to the proposal from the addressed at least one collaborative constituent;
forming a reply for delivery to the host computer including an address of at least one collaborative constituent in accordance with a second workflow identifying a predefined order of delivery thereof; and
receiving a negotiated set of the parameters for the loyalty program to which each remaining said collaborative constituent has agreed, wherein each said collaborative constituent is selected from a group consisting of the issuer, an acquirer, the merchant, a transaction handler, and combinations thereof.

9. The computer-implemented method as defined in claim 8, wherein:
the transaction handler processes a plurality of the transactions each characterized by one said merchant and one said consumer engaging in one said transaction payable upon a corresponding account that one said issuer has issued to the one said consumer; and
one said merchant submits one said transaction to one said acquirer for processing by the transaction handler who requests one said issuer to obtain payment for one said transaction from the corresponding account, and wherein the one said issuer forwards the payment to the transaction handler who forwards the payment to the one said acquirer to pay the one said merchant for one said transaction.

10. The computer-implemented method as defined in claim 8, wherein the hyperlink references a Uniform Resource Locator address associated with the host computer.

11. The computer-implemented method as defined in claim 8, wherein each said inventory item of the merchant is selected from the group consisting of:
a good or service that the merchant has sold to a consumer in the past;
a good or service that the merchant has available for sale; and
a good or service that the merchant can make available for sale in the future.

12. The computer-implemented method as defined in claim 8, further comprising receiving the negotiated set of the parameters for the loyalty program from at least one implementer of the loyalty program.

13. The computer-implemented method as defined in claim 8, wherein:
each of the proposal, the response, and the reply includes a position of at least one of the collaborative constituents for each said parameter in the loyalty program; and
the position is selected from the group consisting of favor and disfavor.

14. The computer-implemented method as defined in claim 8, wherein receiving the negotiated set of the parameters for the loyalty program to which each remaining said collaborative constituent has agreed further comprises performing one or more times at least one of:
receiving of the response; and
forming of the reply.

15. The computer-implemented method as defined in claim 8, wherein at least one of the request and the proposal includes a parameter selected from the group consisting of:
an identification of a location for which the offer is to be made valid;
an identification of a date range during which the offer is to be considered valid;
an identification of one said collaborative constituent to collaborate on the parameters of the loyalty program having the offer for the selected said inventory item;
an image file that can be used in an ad targeted to the consumer;
a type of an account upon which the transaction for the selected said inventory item from can be made payable; and
a combination of the foregoing.

16. A merchant system for deriving an offer of a reward to be made to a consumer as part of a loyalty program comprising:
means for rendering via a graphical user interface:
a menu of a plurality of inventory items of a merchant; and
a loyalty program collaborative offer icon corresponding to a hyperlink for an address of a host computer;
and
upon receiving a selection of the hyperlink and a menu selection of one said inventory item from the menu:
means for forming a request and a proposal for delivery to the host computer, wherein:
the request includes:
the selected said inventory item; and
an identifier for a merchant;
the proposal includes:
an address of at least one collaborative constituent in accordance with a first workflow identifying a predefined order thereof; and
parameters for a loyalty program including an offer to a consumer to conduct a transaction with the merchant for the menu selection, wherein:
the consumer is to receive a reward upon:
conducting the transaction; and
satisfaction of a condition of the reward;
and
the transaction is made payable upon an account that is issued by an issuer to the consumer;
means for receiving a response to the proposal from the addressed at least one collaborative constituent;
means for forming a reply for delivery to the host computer including an address of at least one collaborative constituent in accordance with a second workflow identifying a predefined order of delivery thereof; and
means for receiving a negotiated set of the parameters for the loyalty program to which each remaining said collaborative constituent has agreed, wherein each said collaborative constituent is selected from a group consisting of the issuer, an acquirer, the merchant, a transaction handler, and combinations thereof.

17. The merchant system as defined in claim 16, wherein the transmission addressed to the loyalty program implementer further includes a criterion for selecting one or more said consumers each of whom is to receive the offer and a corresponding said reward for satisfaction of the condition of the reward.

18. The merchant system as defined in claim 16, the first transmission for delivery to the host computer further comprises the at least one of:
an identification of the geography for which the offer is to be made valid;
an identification of a date range during which the offer is valid;
an identification of a collaborative constituent to collaborate, on terms and conditions of the offer for the selected one said inventory item from the menu;
an image file that can be used in an ad targeted to a consumer;
a type of an account upon which a transaction for the selected one said inventory item from the menu can be made payable; and
a combination of the foregoing.

19. The merchant system as defined in claim 16, wherein the reward is selected from the group consisting of:
a credit to the account;
a percentage discount on a price of the at least one said good or service;
a complementary second said good or service of the merchant;
an amount of cash;
a predetermined amount of points; and
a combination thereof.

20. The merchant system as defined in claim 16, further comprising means for receiving a fourth transmission containing information from the loyalty program implementer and including a notification of an approval of the offer and a confirmation that the offer will be disseminated to at least one said consumer.
